(19) United States
(12) Patent Application Publication
(10) Pub. No.: US 2009/0075684 A1
(43) Pub. Date: Mar. 19, 2009

(54) APPARATUS AND METHOD FOR ROUTING MESSAGE SERVICE

(75) Inventors: Hua Cheng, Shenzhen (CN); Hao Lai, Shenzhen (CN); Youzhu Shi, Shenzhen (CN)

Correspondence Address: DARBY & DARBY P.C., P.O. BOX 770, Church Street Station, New York, NY, 10008-0770, US

(73) Assignee: Huawel Technologies Co., Ltd., Shenzhen (CN)

(21) Appl. No.: 12/323,857

(22) Filed: Nov. 26, 2008

Related U.S. Application Data
(63) Continuation of application No. PCT/CN2007/070067, filed on May 30, 2007.

(30) Foreign Application Priority Data
May 31, 2006 (CN) 200610085159.3

(51) Int. Cl. H04W 4/12

(52) U.S. Cl. 455/466

(57) ABSTRACT

The present invention discloses an apparatus for routing message services, including a message service information transmitting module, adapted to send a request message which carries message service information that associates the message service information receiver; a message service information route selecting module, adapted to send message service information to a message service information interworking interface module; and the message service information interworking interface module, adapted to the transfer the message service information to the home network of the message service information receiver. The invention also discloses a method for routing message services.

### CROSS-REFERENCE TO RELATED APPLICATIONS

This application is a continuation of International Application No. PCT/CN2007/070067, filed on May 30, 2007, which claims priority to Chinese Patent Application No. 200610085159.3, filed with the Chinese Patent Office on May 31, 2006, both of which are incorporated herein by reference in their entireties.

### FIELD OF THE INVENTION

The present invention relates to communication technologies and in particular to an apparatus and a method for routing message services.

### BACKGROUND OF THE INVENTION

The IP Multimedia Subsystem (IMS) is a core subsystem in a Next Generation Network (NGN). With the packet domain as the bearer of its upper layer control signaling and media transport, with Session Initiation Protocol (SIP) as its service control protocol to make use of the simple implementation, easy scalability and convenient media combination of SIP, the IMS separates service control from bearer control and provides rich multimedia services.

Main functional entities in an IMS include a Call Session Control Function (CSCF) that controls user registration and sessions, an application server message service control unit that provides various service logic control functions, a Home Subscriber Server (HSS) that manages user subscription data in a centralized way, and a Media Gateway Control Function (MGCF) that interworks with circuit switched networks. A user accesses the network via a local P-CSCF of the visited location while session and service triggering control and service control interaction with the message service control unit are implemented by a home service node control unit in the registration location.

There are multiple types of message services provided in mobile and fixed networks. Some services are supported by both mobile and fixed networks, and some services are only supported by the mobile network or the fixed network. For example, text message services, like Short Message Service (SMS), are applied in mobile networks while instant message services are applied in fixed networks. Message services provided in a mobile network include text message service and Multimedia Message Service (MMS). Message services provided in a network include Instant Message (IM) and chat.

The following describes a technical solution in the prior art that implements text message service and MMS based on Internet Protocol (IP) with reference to FIGS. 1-3:

The 3rd Generation Partnership Project (3GPP) TS 23.804: Technical Specification Group Services and System Aspects; Support of SMS and MMS over generic 3GPP IP access defines an architecture for implementing IP-based text message service and MMS. FIG. 1 shows an architecture 100 that implements text message service and MMS based on IP as defined in 3GPP TS 23.804.

In the network shown in FIG. 1, the functions of main entities are as follows:

Short Message Service Center (SM-SC) 104, adapted to relay, store and forward short messages between a base station and a Short Message Entity (SME);

GMSC/SMS-IWMSC 108: MSC is a Mobile-services Switching Centre; SMS-GMSC is a Gateway MSC for Short Message Service; SMS-IWMSC is an Interworking MSC for Short Message Service;

IP-Message-GW 114: An IP Short Message Gateway that transfers short messages between a user equipment (UE) and the SM-SC.

The following describes a message flow in the network shown in FIG. 1 with reference to FIG. 2.

FIG. 2 shows a message flow in the network shown in FIG. 1. The message flow includes:

S202: A UE registers with the IP-Message-GW;

S204: The UE sends an SMS message to the IP-Message-GW;

S206: The IP-Message-GW transfers the SMS message to the SMS-IWMSC;

S208: The SMS-IWMSC transfers the SMS message to the SM-SC;

S210: The SM-SC sends a delivery report to the SMS-IWMSC;

S212: The SMS-IWMSC sends the delivery report to the IP-Message-GW;

S214: The IP-Message-GW sends the delivery report to the UE.

FIG. 3 shows an MMS origination procedure in the network shown in FIG. 1, including:

S302: Registration procedure;

S304-S308: A UE sends an MMS message to the IP-Messaging-GW;

S310: The IP-Messaging-GW sends the MMS message to the recipient UE;

S312-S314: A response message indicating successful delivery of the MMS message is received;

S316-S322: When the originating UE requests a delivery notification, a delivery notification is sent to the MMS originating UE via an SMS message; and

S324-S330: The delivery notification SMS is transmitted to the MMS originating UE.

When a UE accesses an network, it is needed to route the message to the IP-Message-GW. However, in the prior art, the technical solution proposed by 3GPP TS 23.804 does not solve the routing issue.

With reference to FIG. 4, another technical solution in the prior art for implementing IP-based SMS and MMS is described in detail as follows.

The prior art also provides a routing method for message service and SMS interworking: UE originated message service information is routed to a Breakout Gateway Control Function (BGCF); the BGCF routes the message service information to the IP-SM-GW and finally the IP-SM-GW transfers the message service information to the SMS network of the message terminator.

FIG. 4 shows a successful mobile originated (MO) message to SMS submit procedure in the network system according to the routing method for message service and SMS interworking in the prior art. The procedure includes:

S402: A UE is registered in the network successfully;

S404: The UE sends message service information to the S-CSCF;

S406: The S-CSCF checks the receiver identifier carried in the message service information and if the S-CSCF does not find a SIP Uniform Resource Identifier (SIP URI) associated with the receiver identifier, the S-CSCF routes the message service information to the BGCF;

S408: The BGCF selects to transmit the message service information to the IP-SM-GW according to a local policy;

S410: The IP-SM-GW performs service authentication; and

S412-S416: The IP-SM-GW forwards the message indicating that information is received to the UE.

However, the above technical solution only solves the routing for interworking between non-session based message service and SMS. The technical solution neither solves the problem of interworking between a session based message service and MMS nor solves the problem of interworking between a session based message service and a message service in a heterogeneous network such as the traditional circuit switched domain.

### SUMMARY OF THE INVENTION

Embodiments of the invention intend to provide an apparatus and a method for routing message services so as to solve the routing of a message by the network to the IP-Message-GW when a user equipment (UE) accesses, solve the problem of interworking between a non-session based message service and the multimedia message service, and solve the problem of interworking between a session based message service and a message service in a heterogeneous network such as a traditional circuit switched network.

The purpose of embodiments of the invention is implemented through the following technical solution:

An apparatus for routing message services includes:

a message service information transmitting module, configured to send a request, wherein the request carries a message service information associating a message service information receiver;

a message service information route selecting module, configured to receive the request and send the message service information carried in the request; and

a message service information interworking interface module, configured to receive the message service information and send the message service information to a home network of the message service information receiver.

A method for routing message services includes:

sending a request, carrying a message service information and an identification of a message service information receiver corresponding to the message service information receiver;

determining whether the message service information receiver is a traditional electrical domain user based on the identification of the message service information receiver; and

transmitting the message service information to a home network of the message service information receiver when the message service information receiver is a traditional electrical domain user.

With the above technical solution, embodiments of the invention achieve the following technical effects:

The technical solution provided by embodiments of the invention judges that the home network of the message service information receiver is a traditional circuit switched network according to the message service information receiver identifier, and judges whether message service information is carried via a session request message or an outside session message, and then transfers the message service information to the home short message network of the message service information receiver. With the technical solution, the network is able to route a message to the IP-Messaging-GW when a UE accesses. The technical solution also solves the problem of interworking between non-session based message service and the multimedia message service as well as the interworking between session-based message service and the message service in a heterogeneous network such as the traditional circuited switched domain.

The characteristics and advantages of the invention will be detailed in the following description and some of them are apparent from the description or are understandable via implementation of the invention. The purpose and other advantages of the invention may be achieved and obtained through the structures particularly noted in the description, the claims and the accompanying drawings herein.

### BRIEF DESCRIPTION OF THE DRAWINGS

The drawings herein are provided for better understanding of the present invention and they constitute a part of the application. The exemplary drawings and their descriptions are used to explain the invention and should not be understood as any limitation to the invention. In the accompanying drawings:

FIG. 1 shows the architecture for implementing IP-based SMS and MMS as defined in 3GPP TS 23.804 in the prior art;

FIG. 2 shows a message flow in the network shown in FIG. 1;

FIG. 3 shows an MMS origination procedure in the network shown in FIG. 1;

FIG. 4 shows a successful MO message to SMS submit procedure in the network system proposed by Ericsson;

FIG. 5 shows a message service routing apparatus 500 according to an embodiment of the present invention;

FIG. 6 shows a message service routing method according to an embodiment of the present invention;

FIG. 7 shows a specific implementation of the message service routing method shown in FIG. 6;

FIG. 8 shows a message flow according to embodiment 101 of the present invention;

FIG. 9 shows a message flow according to embodiment 102 of the present invention;

FIG. 10 shows a message flow according to embodiment 103 of the present invention;

FIG. 11 shows a message flow according to embodiment 104 of the present invention;

FIG. 12 shows a message flow according to embodiment 105 of the present invention;

FIG. 13 shows a message flow according to embodiment 111 of the present invention;

FIG. 14 shows a message flow according to embodiment 112 of the present invention;

FIG. 15 shows a message flow according to embodiment 113 of the present invention;

FIG. 16 shows a message flow according to embodiment 206 of the present invention;

FIG. 17 shows a message flow according to embodiment 201 of the present invention;

FIG. 18 shows a message flow according to embodiment 202 of the present invention;

FIG. 19 shows a message flow according to embodiment 205 of the present invention;

FIG. 20 shows a message flow according to embodiment 207 of the present invention;

FIG. 21 shows a message flow according to embodiment 208 of the present invention;

FIG. 22 shows a message flow according to embodiment 209 of the present invention;

FIG. 23 shows a message flow according to embodiment 211 of the present invention;

FIG. 24 shows a message flow according to embodiment 212 of the present invention;

FIG. 25 shows a message flow according to embodiment 213 of the present invention;

FIG. 26 shows a message flow according to embodiment 203 of the present invention; and

FIG. 27 shows a message flow according to embodiment 204 of the present invention.

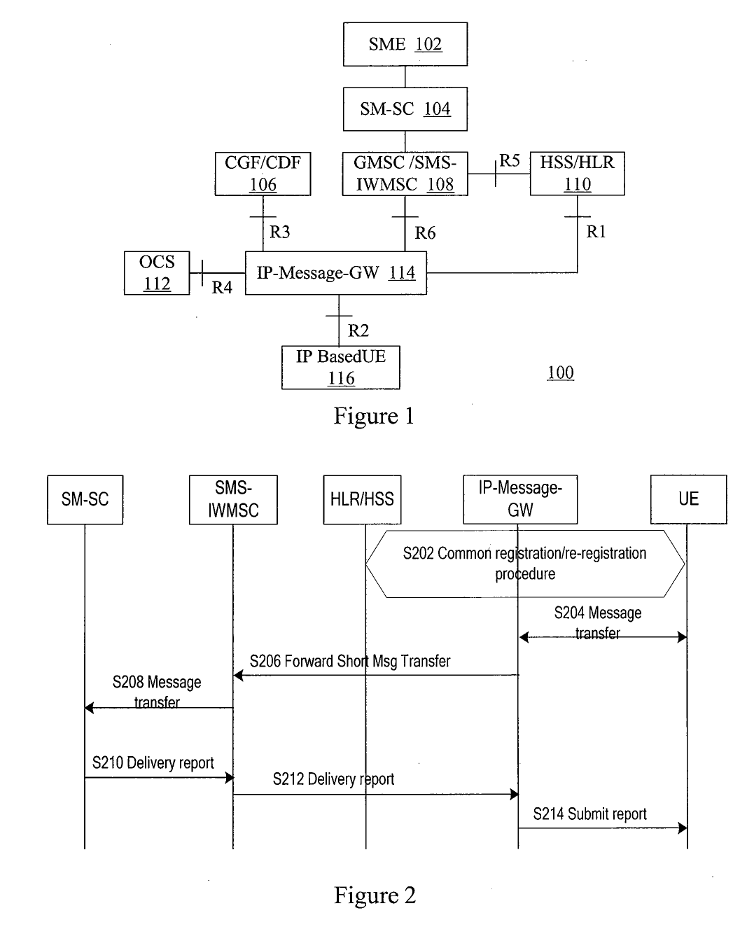

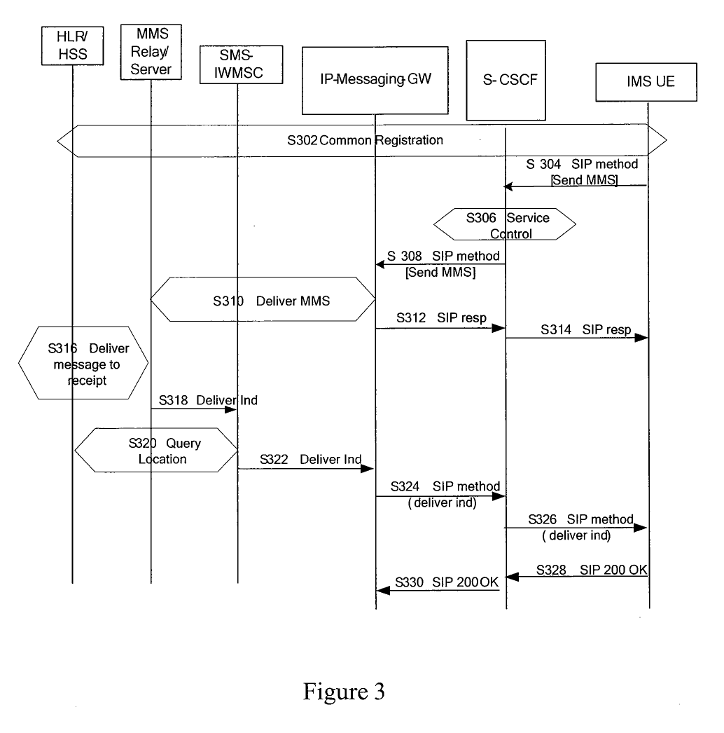

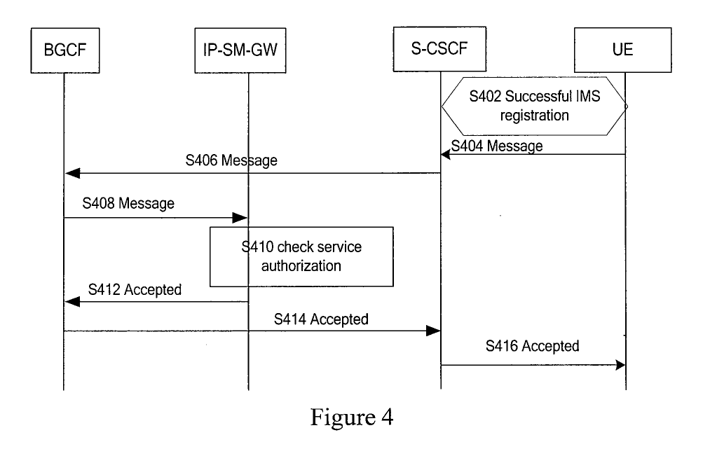

### DETAILED DESCRIPTION OF THE EMBODIMENTS

The following describes the embodiments of the invention with reference to the accompanying drawings.

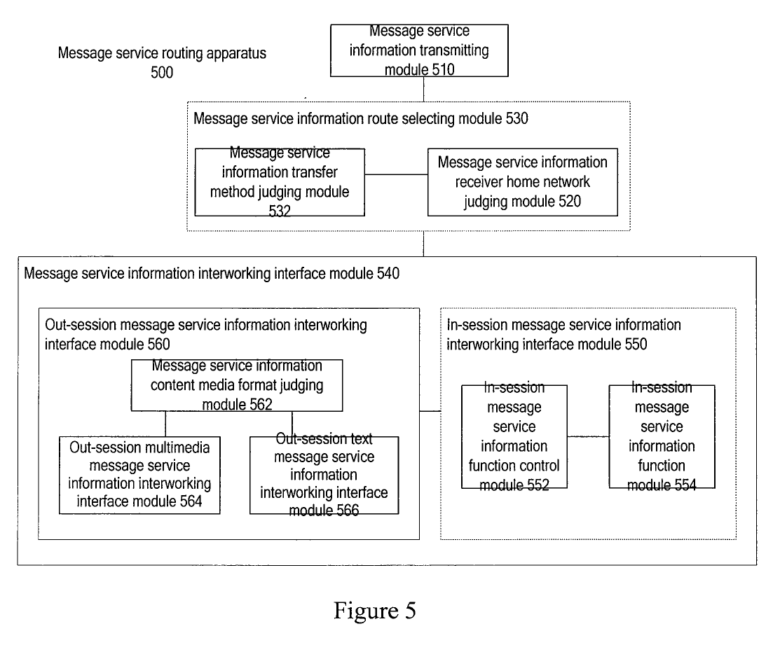

FIG. 5 shows a message service routing apparatus 500 according to an embodiment of the invention.

As shown in FIG. 5, a message service routing apparatus 500 according to an embodiment of the invention includes the following modules:

a message service information transmitting module 510, configured in a user terminal or message service application server, adapted to send message service information to a network;

a message service information route selecting module 530, adapted to judge whether a home network, to which receiver of message service information belongs, is a heterogeneous network, such as a traditional circuit switched domain, and if the receiver of message service information is a heterogeneous network, send the message service information to a message service information interworking interface module 540; and

a message service information interworking interface module 540, adapted to route message service information to the home network of the message service information receiver.

The message service information route selecting module 530 includes:

a message service information transfer method judging module 532, adapted to judge whether to transfer message service information within a session or in message signaling (outside the session); and

a message service information receiver home network judging module 520, adapted to judge whether the home network of the message service information receiver is an IP network or a heterogeneous network such as a traditional circuit switched network.

When the message service information transfer method judging module 532 judges that the message service information is outside the session, the message service information route selecting module 530 includes at least one of the following modules:

a first transmitting module, adapted to enable the message service information route selecting module 530 to transfer the out-session message service information to an out-session multimedia message service information interworking interface module, which sends the out-session message service information to the home multimedia message service network of the message service information receiver;

a second transmitting module, adapted to enable the message service information route selecting module 530 to transfer the out-session message service information to an out-session text message service information interworking interface module, which sends the out-session message service information to the home text message service network of the message service information receiver;

a third transmitting module, adapted to enable the message service information route selecting module to transfer the out-session message service information to a message service information content media format judging module, which checks the content format of the out-session message service information and sends the out-session message service information in the multimedia format to the out-session multimedia message service information interworking interface module, which sends the out-session message service information to the home multimedia message service network of the message service information receiver;

a fourth transmitting module, adapted to enable the message service information route selecting module 530 to transfer the out-session message service information to a message service information content media format judging module, which checks the content format of the out-session message service information and sends the out-session message service information in the multimedia format to the out-session text message service information interworking interface module, which sends the out-session message service information to the home text message service network of the message service information receiver;

a fifth transmitting module, adapted to enable the message service information route selecting module 530 to transfer the out-session message service information to a message service information content media format judging module, which checks the content format of the out-session message service information and sends the out-session message service information in the text format to the out-session text message service information interworking interface module, which sends the out-session message service information to the home text message service network of the message service information receiver; and

a sixth transmitting module, adapted to enable the message service information route selecting module to transfer the out-session message service information to a message service information content media format judging module, which checks the content format of the out-session message service information and sends the out-session message service information in the text format to the out-session multimedia message service information interworking interface module, which sends the out-session message service information to the home multimedia message service network of the message service information receiver.

The message service information interworking interface module 540 includes:

an in-session message service information interworking interface module 550, adapted to route a message service information transferred within a session to the home network of the message service information receiver; and

an out-session message service information interworking interface module 560, adapted to route a message service information transferred outside a session to the home network of the message service information receiver.

The in-session message service information interworking interface module 550 includes:

an in-session message service information control module 552, adapted to set up, tear down, and manage sessions between the message service information transmitting module and the in-session message service information module; and

an in-session message service information function module 554, adapted to send in-session message service information to an in-session message service information transmitting interface module; and

an in-session message service information transmitting interface module 556, adapted to send message service information transferred within a session to the home message service network of the message service information receiver.

The out-session message service information interworking interface module 560 includes:

a message service information content media format judging module 562, adapted to check the content format of the message service information;

an out-session multimedia message service information interworking interface module 564, adapted to send message service information in the multimedia format outside a session to the home multimedia message service network of the message service information receiver; and

an out-session text message service information interworking interface module 566, adapted to send a message service information in the text format outside a session to the home text message service network of the message service information receiver.

In the message service routing apparatus 500 according to an embodiment of the invention, the message service information transmitting module 510 sends a message service information to the message service information route selecting module 530, the message service information route selecting module 530 sends the message service information whose receiver is a heterogeneous network such as a traditional circuit switched network to the message service information interworking interface module 540, and the message service information interworking interface module 540 sends the message service information to the home short message service network of the message service receiver.

The in-session message service information transmitting interface module 556 is able to differentiate the format type of a message service information and send the message service information to the home network of the message service information receiver.

In the message service route selecting module 530, message service information may be transferred along the following paths:

Message service information is routed to the message service information receiver home network judging module 520, which forwards the message service information to the message service information interworking interface module 540;

Message service information is routed to the message service information receiver home network judging module 520, which forwards the message service information to the message service information transfer method judging module 532, which forwards the message service information to the message service information interworking interface module 540; and

Message service information is routed to the message service information transfer method judging module 532, which forwards the message service information to the message service information receiver home network judging module 520, which forwards the message service information to the message service information interworking interface module 540.

In the message service information interworking interface module 540, message service information may be transferred along the following paths:

Message service information is routed to the in-session message service information interworking interface module 550, which forwards the message service information to the home short message service network of the message service information receiver; and

Message service information is routed to the out-session message service information interworking interface module 560, which forwards the message service information to the home short message service network of the message service information receiver.

In the out-session message service interworking interface module 560, message service information may be transferred along the following paths:

Message service information bypasses the message service information content media format judging module 562 and is transferred to the out-session multimedia message service information interworking interface 564, which forwards the message service information to the home multimedia message service network of the message service information receiver;

Message service information bypasses the message service information content media format judging module 562 and is transferred to the out-session text message service information interworking interface 566, which forwards the message service information to the home text message service network of the message service information receiver;

Message service information is transferred to the message service information content media format judging module 562, which forwards the message service information to the out-session multimedia message service information interworking interface module 564, which forwards the message service information to the home multimedia message service network of the message service information receiver; and

Message service information is transferred to the message service information content media format judging module 562, which forwards the message service information to the out-session text message service information interworking interface module 566, which forwards the message service information to the home text message service network of the message service information receiver.

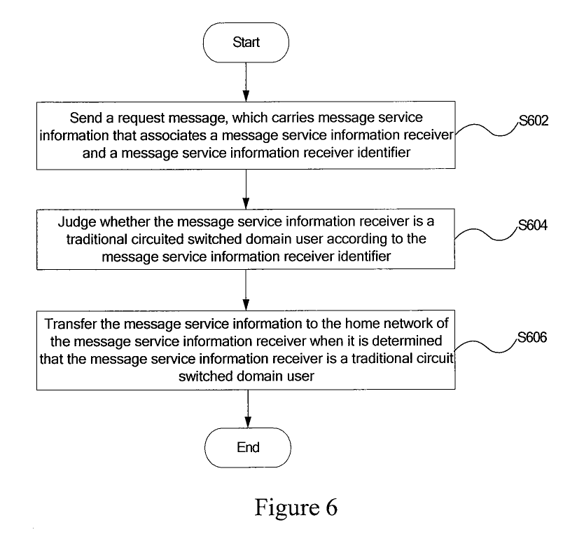

FIG. 6 shows a message service routing method according to an embodiment of the invention.

As shown in FIG. 6, a message service routing method according to an embodiment of the invention includes the following steps:

S602: A request, which carries a message service information that associates the message service information receiver and a message service information receiver identifier, is sent. The request may be out-session message service information or a session request message.

S604: It is judged whether the message service information receiver is a heterogeneous network such as a traditional circuit switched domain user according to the message service information receiver identifier.

S606: The message service information is routed to the home short message service network of the message service information receiver when it is determined that the message service information receiver is a traditional circuit switched domain user.

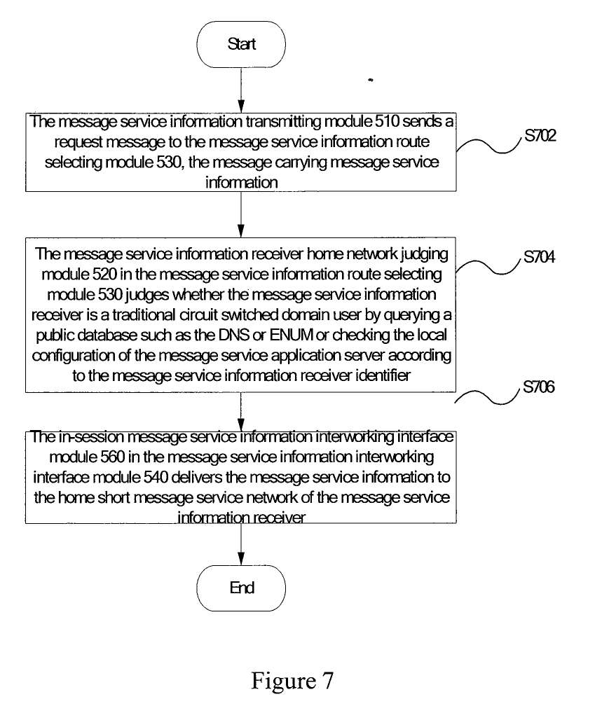

FIG. 7 shows a specific implementation of the message service routing method shown in FIG. 6.

Optionally, as shown in FIG. 7, a detail implementation scheme of the message service routing method according to an embodiment of the invention is as follows:

S702: The message service information transmitting module 510 sends a request to the message service information route selecting module 530. The request carrying a message service information that associates the message service information receiver and the message service information receiver identifier.

S704: The message service information receiver home network judging module 520 in the message service information route selecting module 530 judges whether the home network of the message service information receiver is a heterogeneous network such as a traditional circuit switched domain by querying a public database such as Domain Name Server (DNS) or Telephone Number Mapping (ENUM) or checking the local configuration of the message service application server according to the message service information receiver identifier. The message service information transfer method judging module 532 in the message service information route selecting module 530 is able to judge whether the message service information is in-session message service information according to the type of the message that carries the message service information. The message service information route selecting module 530 may transfer message service information to the message service information interworking interface module 540 in the following methods:

The message service information receiver home network judging module 520 transfers the message service information of the home network to which the receiver of the message services belongs is a heterogeneous network such as a traditional circuit switched domain to the in-session message service information interworking interface module 550;

The message service information receiver home network judging module 520 transfers the message service information of the home network to which the receiver of the message services belongs is a heterogeneous network such as a traditional circuit switched domain to the out-session message service information interworking interface module 560;

The message service information receiver home network judging module 520 transfers the message service information of the home network to which the receiver of the message services belongs is a heterogeneous network such as a traditional circuit switched domain to the message service information transfer method judging module 532, which forwards the message service information transferred within the session to the in-session message service information interworking interface module 550;

The message service information receiver home network judging module 520 transfers the message service information of the home network to which the receiver of the message services belongs is a heterogeneous network such as a traditional circuit switched domain to the message service information transfer method judging module 532, which forwards the message service information transferred outside the session to the out-session message service information interworking interface module 560;

The message service information transfer method judging module 532 judges whether the message service information is in-session or out-session and transfers the message service information to the message service information receiver home network judging module 520, which judges whether the home network of the receiver is a heterogeneous network such as a traditional circuit switched network and forwards the in-session message service information of the home network whose receiver is a heterogeneous network such as a traditional circuit switched network to the in-session message service information interworking interface module 550; and

The message service information transfer method judging module 532 judges whether the message service information is in-session or out-session and transfers the message service information to the message service information receiver home network judging module 520, which judges whether the home network to which the receiver of the message services belongs is a heterogeneous network such as a traditional circuit switched network and forwards the out-session message service information of the home network to which the receiver of the message services belongs is a heterogeneous network such as a traditional circuit switched network to the out-session message service information interworking interface module 560.

S706: The in-session message service information interworking interface module 550 in the message service information interworking interface module 540 may transfer the message service information to the home short message service network of the message service information receiver in the following methods:

The in-session message information interworking interface module 550 sends a response to the message service information session request to the message service information transmitting module 510 to set up a session between the in-session message service information function module 554 and the message service information transmitting module 510. The message service information transmitting module 510 sends a message service information to the in-session message service information interworking interface module 550 within the session. The in-session message service information interworking interface module 550 forwards the message service information to the home multimedia message service network or text message service network of the message service information receiver.

The in-session message information interworking interface module 550 sends a response to the message service information session request to the message service information transmitting module 510 to set up a session between the in-session message service information function module 554 and the message service information transmitting module 510. The message service information transmitting module 510 sends a message service information to the in-session message service information interworking interface module 550 within the session. The in-session message service information interworking interface module 550 forwards the message service information to the out-session message service information interworking interface module 560, which delivers the message service information to the home short message service network of the message service information receiver.

The in-session message service information function control module 552 sends a control message which carries the information of the message service information session request to the in-session message service information function module 554, and requests the in-session message service information function control module 554 to provide a resource for a message service information session. The in-session message service information function module 554 assigns the resource required by the message service information session, and sends a success response which carries a response information of message service information session request to the in-session message service information function control module 552 to set up a session between the in-session message service information function module 554 and the message service information transmitting module 510. The message service information transmitting module 510 sends a message service information to the in-session message service information function module 554 within the session. The in-session message service information interworking interface module 550 delivers the message service information to the home multimedia message service network or text message service network of the message service information receiver in the following methods:

Upon reception of message service information within the session, the in-session message service information function module 554 sends a notification message to the in-session message service information function control module 552, and notifies the in-session message service information function control module 552 of the coming of in-session message service information. The in-session message service information function control module 552 sends an indication to the in-session message service information function module 554, and instructs the in-session message service information function module 554 to send the message service information to the in-session message service transmitting interface module 556. The in-session message service transmitting interface module 556 delivers the message service information to the home multimedia message service network or text message service network of the message service information receiver.

Upon reception of message service information within the session, the in-session message service information function module 554 extracts the message service information and sends the extracted message service information to the in-session message service information transmitting interface module 556, which delivers the message service information to the home multimedia message service network or text message service network of the message service information receiver.

Optionally, if the session request message carries call information in addition to message service information, the call information is sent to the call request receiver and the response information to the message service information session request is carried in the call session setup success response message and sent to the message service information transmitting module 510.

The out-session message service information interworking interface module 560 in the message service information interworking interface module 540 may deliver the message service information to the home message service network of the short message service information receiver in the following manners:

Bypassing the message service information content media format judging module 562, message service information in text format and multimedia format is delivered by the out-session multimedia message service information interworking interface module 564 to the home multimedia message service network of the message service information receiver.

Bypassing the message service information content media format judging module 562, message service information in text format and multimedia format is delivered by the out-session text message service information interworking interface module 566 to the home text message service network of the message service information receiver.

The message service information content media format judging module 562 transfers message service information in the multimedia format to the out-session multimedia message service information interworking interface module 564, which delivers the message service information in the multimedia format to the home multimedia message service network of the message service information receiver.

The message service information content media format judging module 562 transfers message service information in the multimedia format to the out-session text message service information interworking interface module 566, which delivers the message service information in the multimedia format to the home text message service network of the message service information receiver.

The message service information content media format judging module 562 transfers message service information in the text format to the out-session text message service information interworking interface module 566, which delivers the message service information in the text format to the home text message service network of the message service information receiver.

The message service information content media format judging module 562 transfers message service information in the text format to the out-session multimedia message service information interworking interface module 564, which delivers the message service information in the text format to the home multimedia message service network of the message service information receiver.

The following describes multiple embodiments of the invention when the message service information transmitting module transmits out-session message service information. In these embodiments, the receiver network is a multimedia message service network or a text message service network. The message service information is routed in the same routing principle except that the receiver network is different. Therefore, one routing method is provided with one embodiment in a multimedia message service network or a text message service network, for the implementation of the other scenario is known by deduction.

### Embodiment 101

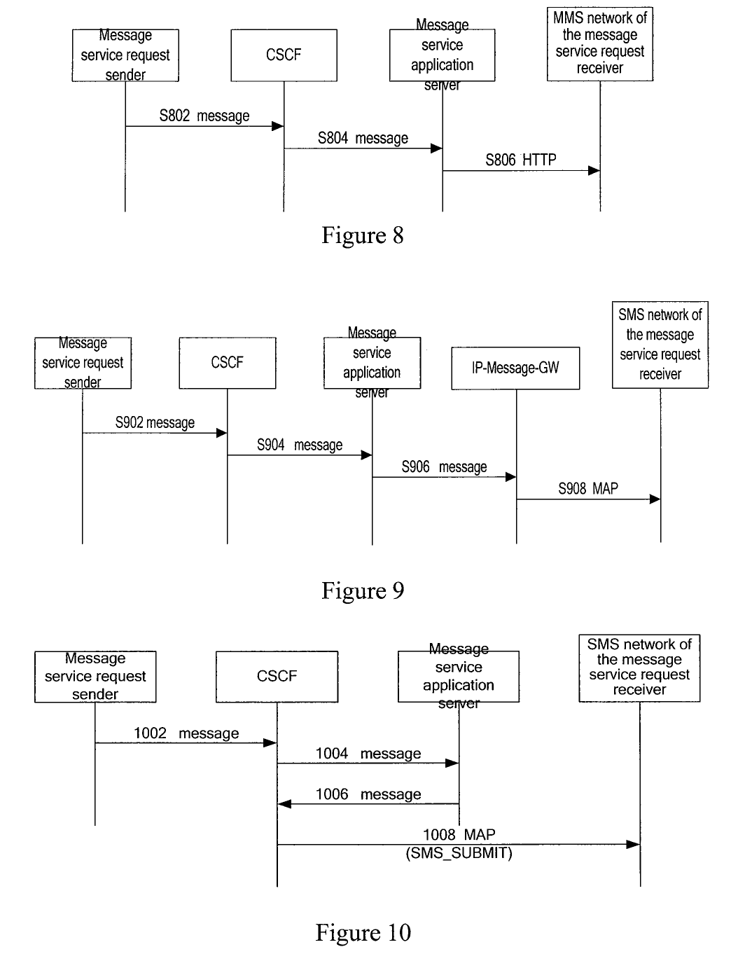

FIG. 8 shows a message flow according to embodiment 101 of the invention.

The message service information receiver home network judging module 520 is placed in the message service application server entity; the message service information route selecting module 530 is placed in the message service application server entity.

The message flow of the embodiment is as follows:

S802: The message service information transmitting module 510 sends out-session message service information, such as a message, to the Call Session Control Function (CSCF) and the out-session message service information carries message service information content of the multimedia format. The destination identifier of the message is the identifier of the message service application server. For example, the Request-URI of the message is as_message@.domain.cn. The message header carries the identifier of the message receiver, such as message-destination: 12345678@cs.domain.cn.

S804: The CSCF routes the message service information to the message service application server according to the destination identifier in the message service information.

S806: The message service information receiver home network judging module 520 in the message service application server judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the multimedia type. The out-session multimedia message service information interworking interface module 564 in the message service application server transfers the message service information to the home multimedia message service network of the message service information receiver over the Hypertext Transfer Protocol (HTTP).

### Embodiment 102

FIG. 9 shows a message flow according to embodiment 102 of the invention.

The message service information receiver home network judging module 520 is placed in the message service application server entity; the message service information transfer method judging module 532 is placed in the message service application server entity; the message service information content media format judging module 562 is placed in the message service application server entity; the out-session text message service information interworking interface module 566 is placed in another entity, such as the IP-Messaging-GW.

The message flow of the embodiment is as follows:

S902: The message service information transmitting module 510 sends out-session message service information, such as a message, to the CSCF, and the out-session message service information carries the message service information content of the text format. The destination identifier of the message is the identifier of the message service application server. For example, the Request-URI of the message is as_message@.domain.cn. The message header carries the identifier of the message receiver, such as message-destination: 12345678@cs.domain.cn.

S904: The CSCF routes the message service information to the message service application server according to the destination identifier in the message service information.

S906: The message service information receiver home network judging module 520 in the message service application server judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the text type. The message service application server determines that the out-session text message service information interworking interface module 566 is in another entity according to the local configuration. The message service application server transfers the message service information to the home entity of the out-session text message service information interworking interface module 566, the message carrying routing information, for example, an additional message-route: text message service_interface@ip-messaging-gw.home.cn.

S908: The IP-Messaging-GW transfers the message service information to the home text message service network of the message service information receiver over the Mobile Application Part (MAP).

### Embodiment 103

FIG. 10 shows a message flow according to embodiment 103 of the invention.

The message service information receiver home network judging module 520 is placed in the message service application server entity; the message service information transfer method judging module 532 is placed in the message service application server entity; the message service information content media format judging module 562 is placed in the message service application server entity; the out-session multimedia message service information interworking interface module 564 is placed in the CSCF entity.

The message flow of the embodiment is as follows:

S1002-S1004: Similar to S802-S804 in embodiment 101. The message service information is in the text format and the message carries message service information content in the text format.

S1006: The message service information receiver home network judging module 520 in the message service application server judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the text type. The message service application server determines that the out-session text message service information interworking interface module 566 is in the CSCF entity according to the local configuration. The message service application server transfers the message service information to the CSCF entity, the message carrying routing information, for example, an additional message-route: text message service_interface@s-cscf.home.cn.

S1008: The CSCF determines that the message service information needs to be transferred to the home text message service network of the message service information receiver via the local out-session text message service information interworking interface module 566. The CSCF transfers the message service information to the home text message service network of the message service information receiver over MAP.

Based on this embodiment, the procedures when the modules are distributed as follows can be deduced:

1) The message service information receiver home network judging module 520 and the message service information transfer method judging module 532, the message service information content media format judging module 562, the out-session multimedia message service information interworking interface module 564, and the out-session text message service information interworking interface module 566 may be placed in network entities as follows according to the order of the message flow: the network entity in the first position is the message service application server and the network entity in the second position is the CSCF.

2) The distribution rule is as follows:

When the message service information receiver home network judging module 520 is placed in the message service application server entity and the out-session multimedia message service information interworking interface module 564 or the out-session text message service information interworking interface module 566 is placed in the CSCF entity, the message service information transfer method judging module 532 and the message service information content media format judging module 562 may be placed in either of the network entities described in 1) and the home network entity of the message service information transfer method judging module 532 is in a position ahead of or in a same position as the home network entity of the message service information content media format judging module 562; and

When the message service information receiver home network judging module 520 is placed in the CSCF and the message service information transfer method judging module 532 is placed in the message service application server entity, and the out-session multimedia message service information interworking interface module 564 or the out-session text message service information interworking interface module 566 is placed in the CSCF entity, the message service information content media format judging module 562 is placed in the CSCF entity.

### Embodiment 104

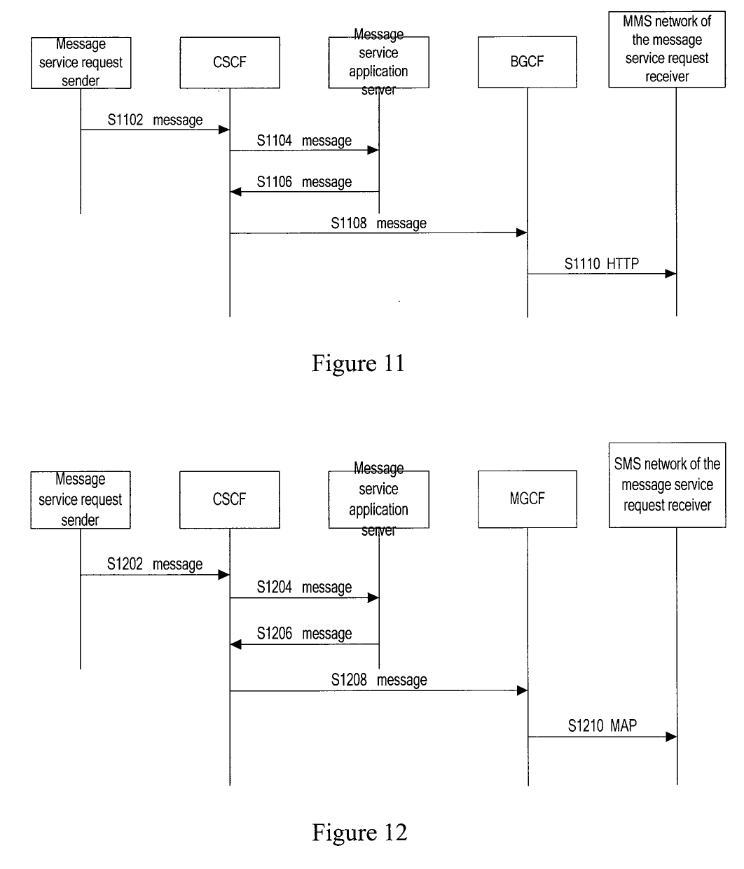

FIG. 11 shows a message flow according to embodiment 104 of the invention.

The message service information receiver home network judging module 520 is placed in the message service application server entity; the message service information transfer method judging module 532 is placed in the message service application server entity; the message service information content media format judging module 562 is placed in the message service application server entity; the out-session multimedia message service information interworking interface module 564 is placed in the Breakout Gateway Control Function (BGCF) entity.

The message flow of the embodiment is as follows:

S1102-S1104: Similar to S802-S804 in embodiment 101.

S1106: The message service information receiver home network judging module 520 in the message service application server judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the multimedia type. The message service application server determines that the out-session multimedia message service information interworking interface module 564 is in the BGCF entity according to the local configuration. The message service application server transfers the message service information to the CSCF, the message carrying routing information, for example, an additional message-route: msm_interface@bgcf.home.cn.

S1108: The CSCF transfers the message service information to the BGCF according to the routing information carried in the message service information.

S1110: The BGCF determines that the message service information needs to be transferred to the home multimedia message service network of the message service information receiver via the local out-session multimedia message service information interworking interface module 564. The MGCF transfers the message service information to the home multimedia message service network of the message service information receiver over HTTP.

Based on this embodiment, the procedures when the modules are distributed as follows can be deduced:

1) The message service information receiver home network judging module 520 and the message service information transfer method judging module 532, the message service information content media format judging module 562, the out-session multimedia message service information interworking interface module 564, and the out-session text message service information interworking interface module 566 may be placed in network entities as follows according to the order of the message flow: the network entity in the first position is the message service application server, the network entity in the second position is the CSCF, and the third position is the BGCF.

2) The distribution rule is as follows:

When the message service information receiver home network judging module 520 is placed in the message service application server entity and the out-session multimedia message service information interworking interface module 564 or the out-session text message service information interworking interface module 566 is placed in the BGCF entity, the message service information transfer method judging module 532 and the message service information content media format judging module 562 may be placed in any of the network entities described in 1) and the home network entity of the message service information transfer method judging module 532 is in a position ahead of or in a same position as the home network entity of the message service information content media format judging module 562; and

When the message service information receiver home network judging module 520 is placed in the CSCF entity and the message service information transfer method judging module 532 is placed in the message service application server entity, and the out-session multimedia message service information interworking interface module 564 or the out-session text message service information interworking interface module 566 is placed in the BGCF entity, the message service information content media format judging module 562 may be placed in any network entity behind the CSCF entity.

### Embodiment 105

FIG. 12 shows a message flow according to embodiment 105 of the invention.

The message service information receiver home network judging module 520 is placed in the message service application server entity; the message service information transfer method judging module 532 is placed in the message service application server entity; the message service information content media format judging module 562 is placed in the message service application server entity; the out-session multimedia message service information interworking interface module 564 is placed in the Media Gateway Control Function (MGCF) entity.

The message flow of the embodiment is as follows:

S1202-S1204: Similar to S902-S904 in embodiment 102.

S1206: The message service information receiver home network judging module 520 in the message service application server judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the text type. The message service application server determines that the out-session text message service information interworking interface module 566 is in the MGCF entity according to the local configuration. The message service application server transfers the message service information to the CSCF, the message carrying routing information, for example, an additional message-route: text message service_interface@mgcf.home.cn.

S1208: The CSCF sends the message service information to the MGCF according to the routing information carried in the message service information, or sends the message service information to the MGCF via the BGCF.

S1008: The MGCF determines that the message service information needs to be transferred to the home text message service network of the message service information receiver via the local out-session text message service information interworking interface module 566. The MGCF transfers the message service information to the home text message service network of the message service information receiver over MAP.

Based on this embodiment, the procedures when the modules are distributed as follows can be deduced:

The message service information receiver home network judging module 520 and the message service information transfer method judging module 532, the message service information content media format judging module 562, the out-session multimedia message service information interworking interface module 564, and the out-session text message service information interworking interface module 566 may be placed in network entities as follows according to the order of the message flow: the network entity in the first position is the message service application server, the network entity in the second position is the CSCF, and the third position is the BGCF, and the network entity in the fourth position is the MGCF; or the network entity in the first position is the message service application server, the network entity in the second position is the CSCF, and the network entity in the third position is the MGCF.

2) The distribution rule is as follows:

When the message service information receiver home network judging module 520 is placed in the message service application server entity and the out-session multimedia message service information interworking interface module 564 or the out-session text message service information interworking interface module 566 is placed in the MGCF entity, the message service information transfer method judging module 532 and the message service information content media format judging module 562 may be placed in any of the network entities described in 1) and the home network entity of the message service information transfer method judging module 532 is in a position ahead of or in a same position as the home network entity of the message service information content media format judging module 562; and

When the message service information receiver home network judging module 520 is placed in the CSCF entity and the message service information transfer method judging module 532 is placed in the message service application server entity, and the out-session multimedia message service information interworking interface module 564 or the out-session text message service information interworking interface module 566 is placed in the MGCF entity, the message service information content media format judging module 562 may be placed in any network entity behind the CSCF entity.

### Embodiment 111

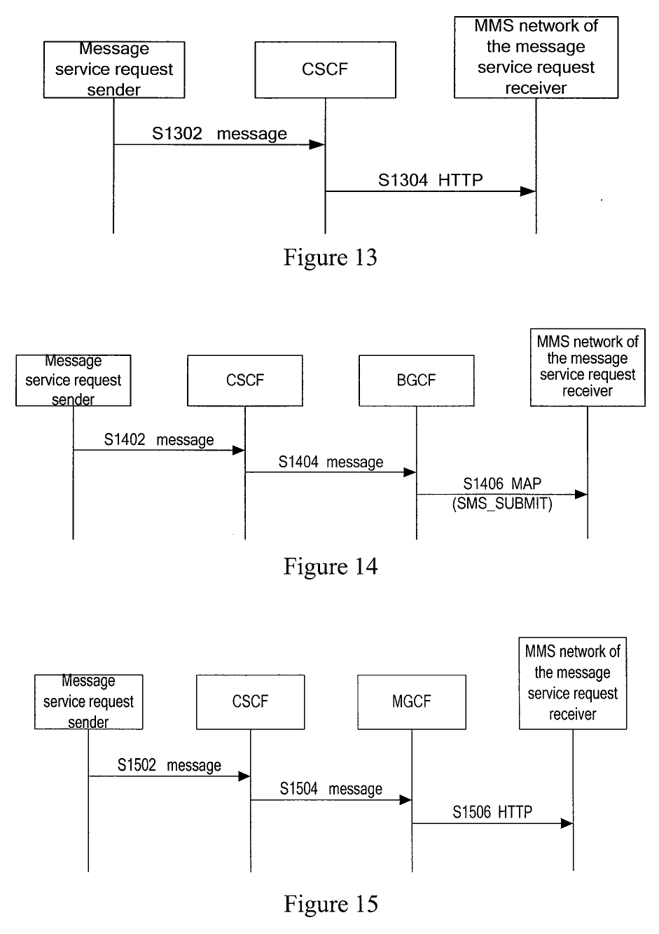

FIG. 13 shows a message flow according to embodiment 111 of the invention.

The message service information receiver home network judging module 520 is placed in the CSCF entity; the message service information interworking interface module is placed in the CSCF entity.

The message flow of the embodiment is as follows:

S1302: The message service information transmitting module 510 sends out-session message service information, such as a message, to the CSCF, and the out-session message service information carries message service information content of the multimedia format. The destination identifier of the message is the receiver identifier, for example, the Request-URI of the message is 12345678@cs.domain.cn.

S1304: The message service information receiver home network judging module 520 in the CSCF judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the multimedia type. The out-session multimedia message service information interworking interface module 564 in the CSCF transfers the message service information to the home multimedia message service network of the message service information receiver over HTTP.

### Embodiment 112

FIG. 14 shows a message flow according to embodiment 112 of the invention.

The message service information receiver home network judging module 520 is placed in the CSCF entity; the message service information transfer method judging module 532 is placed in the CSCF entity; the message service information content media format judging module 562 is placed in the CSCF entity; and the out-session text message service information interworking interface module 566 is place in the BGCF entity.

The message flow of the embodiment is as follows:

S1402: The message service information transmitting module 510 sends out-session message service information, such as a message, to the CSCF, and the out-session message service information carries message service information content of the text format. The destination identifier of the message is the receiver identifier, for example, the Request-URI of the message is 12345678@cs.domain.cn.

S1404: The message service information receiver home network judging module 520 in the CSCF judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the text type. The CSCF determines that the out-session text message service information interworking interface module 566 is in the BGCF entity according to the local configuration. The message service application server transfers the message service information to the BGCF, the message carrying routing information, for example, an additional message-route: text message service_interface@bgcf.home.cn.

S1406: The BGCF determines that the message service information needs to be transferred to the home text message service network of the message service information receiver via the local out-session text message service information interworking interface module 566. The BGCF transfers the message service information to the home text message service network of the message service information receiver over MAP.

Based on this embodiment, the procedures when the modules are distributed as follows can be deduced:

1) The message service information receiver home network judging module 520 and the message service information transfer method judging module 532, the message service information content media format judging module 562, the out-session multimedia message service information interworking interface module 564, and the out-session text message service information interworking interface module 566 may be placed in network entities as follows according to the order of the message flow: the network entity in the first location is the CSCF and the network entity in the second location is the BGCF.

2) The distribution rule is as follows:

When the message service information receiver home network judging module 520 is placed in the CSCF entity and the out-session multimedia message service information interworking interface module 564 or the out-session text message service information interworking interface module 566 is placed in the BGCF entity, the message service information transfer method judging module 532 and the message service information content media format judging module 562 may be placed in any of the network entities described in 1) and the home network entity of the message service information transfer method judging module 532 is in a position ahead of or in a same position as the home network entity of the message service information content media format judging module 562.

### Embodiment 113

FIG. 15 shows a message flow according to embodiment 113 of the invention.

The message service information receiver home network judging module 520 is placed in the CSCF entity; the message service information transfer method judging module 532 is placed in the CSCF entity; the message service information content media format judging module 562 is placed in the CSCF entity; and the out-session multimedia message service information interworking interface module 564 is placed in the MGCF entity.

The message flow of the embodiment is as follows:

S1502: The message service information transmitting module 510 sends out-session message service information, such as a message, to the CSCF, and the out-session message service information carries message service information content of the multimedia format. The destination identifier of the message is the receiver identifier, for example, the Request-URI of the message is 12345678@cs.domain.cn.

S1504: The message service information receiver home network judging module 520 in the CSCF judges that the receiver network of the message service information is a traditional circuit switched network according to the message service information receiver identifier. The message service information transfer method judging module 532 judges that the message service information is transferred outside the session. Optionally, the sequence of the two judgments may be inversed. The message service information content media format judging module 562 judges that the message service information content is of the multimedia type. The CSCF determines that the out-session multimedia message service information interworking interface module 564 is in the MGCF entity according to the local configuration. The message service application server transfers the message service information to the MGCF, or transfers the message service information to the MGCF via the BGCF, the message carrying routing information, for example, an additional message-route: mms_interface@mgcf.home.cn.

S1506: The MGCF determines that the message service information needs to be transferred to the home multimedia message service network of the message service information receiver via the local out-session text message service information interworking interface module 566. The MGCF transfers the message service information to the home multimedia message service network of the message service information receiver over HTTP.

Based on this embodiment, the procedures when the modules are distributed as follows can be deduced:

1) The message service information receiver home network judging module 520 and the message service information transfer method judging module 532, the message service information content media format judging module 562, the out-session multimedia message service information interworking interface module 564, and the out-session text message service information interworking interface module 566 may be placed in network entities as follows according to the order of the message flow: the network entity in the first position is the CSCF, the network entity in the second position is the BGCF, and the third position is the MGCF; or the network entity in the first position is the CSCF, and the network entity in the second position is the MGCF.

2) The distribution rule is as follows:

When the message service information receiver home network judging module 520 is placed in the CSCF entity and the out-session multimedia message service information interworking interface module 564 or the out-session text message service information interworking interface module 566 is placed in the MGCF entity, the message service information transfer method judging module 532 and the message service information content media format judging module 562 may be placed in any of the network entities described in 1) and the home network entity of the message service information transfer method judging module 532 is in a position ahead of or in a same position as the home network entity of the message service information content media format judging module 562.

### And/or Embodiment 201

FIG. 17 shows a message flow according to embodiment 201 of the invention.

The message service information receiver home network judging module 520 is placed in the message service application server; the message service information transfer method judging module 532 is placed in the message service application server; the in-session message service information function control module 552 is placed in the message service application server; the in-session message service information function module 554 is placed in the message service application server; and the in-session message service information transmitting interface module is placed in the message service application server.

The message flow of the embodiment is as follows:

S1702: The message service information transmitting module 510 sends a session request to the CSCF, the message carrying multimedia message service information with the destination identifier set to the identifier of the message service information receiver, for example:

INVITE sip:12345678@cs.domain.cn SIP/2.0
......
Content-Type: application/sdp
Content-Length: (...)
v=0
o=− 2987933615 2987933615 IN IP6 5555::aaa:bbb:ccc:ddd
s=−
c=IN IP6 5555::aaa:bbb:ccc:ddd
t=0 0
m=message 3402 TCP/MSRP*
a=accept-types:message/cpim image/jpeg
a=path:msrp://[5555::aaa:bbb:ccc:ddd]:3402/s111271;tcp
a=max-size:131072

S1704: The CSCF transfers the session request to the message service application server according to the message triggering principle.

S1706: The message service information receiver home network judging module 520 in the message service application server judges that the home network of the message service information receiver is a traditional circuit switched network according to the message service information receiver identifier. The message service information transfer method judging module 532 judges that the message service information is carried via a session request message. The in-session message service information function control module 552 assigns an in-session message service information function module 554. The in-session message service information function control module 552 in the message service application server returns a response of successful session setup to set up a session between the in-session message service information function module 554 and the message service information transmitting module 510. The response message carries message service response information, for example:

SIP/2.0 200 OK
......
Content-Type: application/sdp
Content-Length: (...)
v=0
o=− 2987933615 2987933617 IN IP6 5555:: eee:fff:aaa:bbb
s=−
c=IN IP6 5555::eee:fff:aaa:bbb
t=0 0
m=message 3402 TCP/MSRP *
a=accept-types: image/jpeg message/cpim
a=path:msrp://[5555::eee:fff:aaa:bbb]:3402/s234167;tcp
a=max-size:65536

S1708: The CSCF forwards the response to the message service information transmitting module 510.

S1710: The message service information transmitting 510 sets up a Transport Control Protocol (TCP) connection with the in-session message service information function module 554 according to the address information of the in-session message service information function module 554 carried in the response message.

S1712: The message service information transmitting module 510 uses the send command in the Message Session Relay Protocol (MSRP) over the TCP connection which is set up in Step S1710 to send message service information content to the in-session message service information function module 554.

S1714: The in-session message service information function module 554 sends a response of successful reception to the message service information transmitting module 510.

S1716: The in-session message service information transmitting interface module delivers the message service information to the home multimedia message service network of the message service information receiver over HTTP.

### Embodiment 202

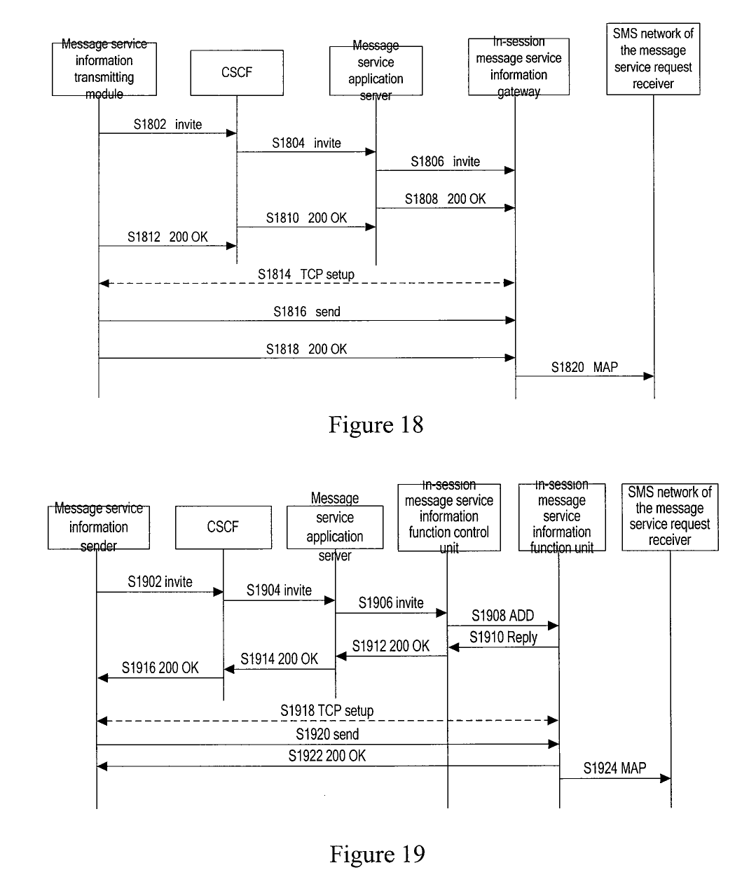

FIG. 18 shows a message flow according to embodiment 202 of the invention.

The message service information receiver home network judging module 520 is placed in the message service application server; the message service information transfer method judging module 532 is placed in the message service application server; and the in-session message service information function control module 552 and the in-session message service information function module 554, and the in-session message service information transmitting interface module are in another network entity, which is identified as an in-session message service information gateway in the figure.

The message flow of the embodiment is as follows:

S1802: The message service information transmitting module 510 sends a session request to the CSCF, the message carrying text message service information with the destination identifier set to the identifier of the message service information receiver, for example:

INVITE sip:12345678@cs.domain.cn SIP/2.0
......
Content-Type: application/sdp
Content-Length: (...)
v=0
o=− 2987933615 2987933615 IN IP6 5555::aaa:bbb:ccc:ddd
s=−
c=IN IP6 5555::aaa:bbb:ccc:ddd
t=0 0
m=message 3402 TCP/MSRP*
a=accept-types:message/cpim text/plain text/html
a=path:msrp://[5555::aaa:bbb:ccc:ddd]:3402/s111271;tcp
a=max-size:131072

S1804: The CSCF transfers the session request to the message service application server according to the message triggering principle.

S1806: The message service information receiver home network judging module 520 in the message service application server judges that the home network of the message service information receiver is a traditional circuit switched network according to the message service information receiver identifier. The message service information transfer method judging module judges that the message service information is carried via a session request. The message service application server determines that the in-session message service information function control module 552 is in the in-session message service information gateway according to local data configuration. The message service application server sends the session request to the in-session message service information gateway.

S1808: The in-session message service information function control module 552 in the in-session message service information gateway assigns an in-session message service information function module 554. Upon successful assignment, the in-session message service information function control module 552 in the in-session message service information gateway returns a response of successful session setup to set up a session between the in-session message service information function module 554 and the message service information transmitting module 510. The response message carries message service response information, for example:

SIP/2.0 200 OK
......
Content-Type: application/sdp
Content-Length: (...)
v=0
o=− 2987933615 2987933617 IN IP6 5555:: eee:fff:aaa:bbb
s=−
c=IN IP6 5555::eee:fff:aaa:bbb
t=0 0
m=message 3402 TCP/MSRP *
a=accept-types:text/plain text/html message/cpim
a=path:msrp://[5555::eee:fff:aaa:bbb]:3402/s234167;tcp
a=max-size:65536

S1810-S1812: The response is forwarded to the message service information transmitting module 510.

S1814-S1818: Similar to S1710-S1714 in embodiment 201.

S1820: The in-session message service information transmitting interface module delivers the message service information to the home text message service network of the message service information receiver over MAP.

The procedures in the in-session message service information function control module 552, the in-session message service information function module 554, and the in-session message service information transmitting interface module in this embodiment and the procedures in other modules in other embodiments can be combined to deduce the handling procedures and methods in combined situations, without further examples herein.

### Embodiment 203

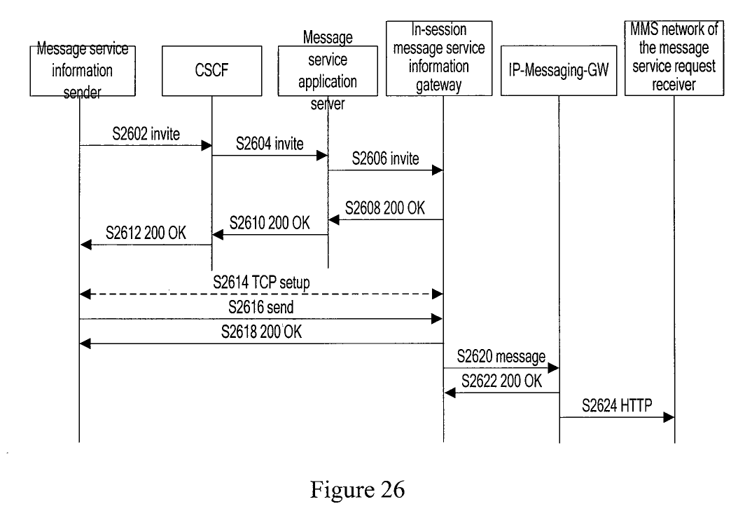

FIG. 26 shows a message flow according to embodiment 203 of the invention.

The message service information receiver home network judging module 520 is placed in the message service application server; the message service information transfer method judging module 532 is placed in the message service application server; the in-session message service information function control module 552 and the in-session message service information function module 554, are placed in another network entity, which is identified as an in-session message service information gateway in the figure; and the in-session message service information transmitting interface module is in another network entity, such as the IP-Messaging-GW.

The message flow of the embodiment is as follows:

S2602-S2618: Similar to S1802-S1818 in embodiment 202. The message service information is of the multimedia type.

S2620: The in-session message service information gateway sends the message service information to the IP-Messaging-GW.

S2622: The IP-Messaging-GW sends a response of success to the in-session message service information gateway.

S908: The IP-Messaging-GW transfers the message service information to the home multimedia message service network of the message service information receiver over HTTP.

The procedures in the in-session message service information function control module 552, the in-session message service information function module 554, and the in-session message service information transmitting interface module in this embodiment and the procedures in other modules in other embodiments can be combined to deduce the handling procedures and methods in combined situations, without further examples herein.

### Embodiment 204

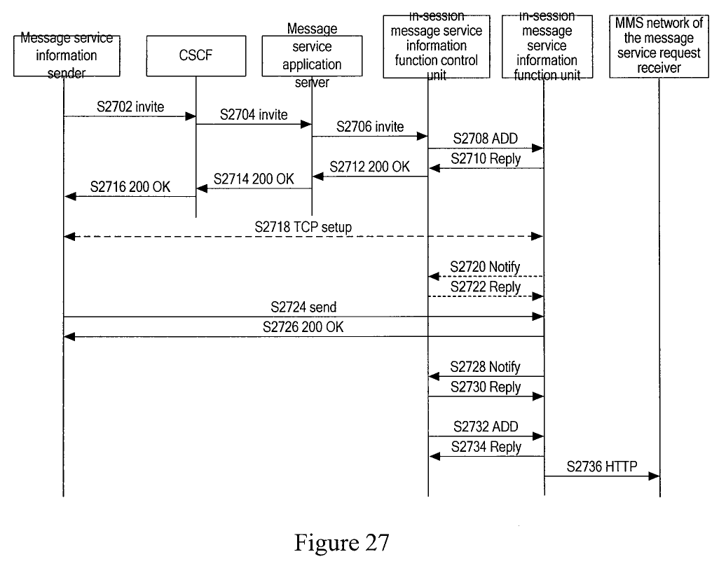

FIG. 27 shows a message flow according to embodiment 204 of the invention.

The message service information receiver home network judging module 520 is placed in the message service application server; the message service information transfer method judging module 532 is placed in the message service application server; the in-session message service information function control module 552 is placed in another network entity, such as an in-session message service information function control unit; and the in-session message service information function module 554 and the in-session message service information transmitting interface module are in another network entity, such as an in-session message service information function unit.

The embodiment extends the H.248 short message data package so that it is able to carry short message information,

Definition of Short Message Data Package:

PackageID: normal int (such as 0xCE)

Properties:

Property Name Short Message Destination URI

PropertyID: SM Destination URI (0x0001)

Description: Defines the URI address of the message service information receiver.

Type: string

Defined in: Local Control descriptor

Characteristics: Read/Write

Property Name Short Message Destination Address

PropertyID: SM Destination Address (0x0001)

Description: Defines the integer address of the message service information receiver.

Type: Integer

Defined in: Local Control descriptor

Characteristics: Read/Write

Property Name Short Message Protocol Type

PropertyID: SM Protocol Type (0x0002)

Description: Defines the message service information transport protocol of the message service information receiver, such as HTTP, SMTP and MAP.

Type: string

Defined in: Local Control descriptor

Characteristics: Read/Write

Events:

Event Name Connection Finished

EventID: cf (0x0003)

Description: The in-session message service information transfer channel is set up successfully.

Event Name: Short Message Arrived

EventID: ad (0x0004)

Description: In-session message service information arrived.

Statistics: none

Signals: none

Procedures: MGC may carry a short message data package in any command.

The message flow of the embodiment is as follows:

S2702: Similar to S1702 in embodiment 201.

S2704: The CSCF transfers the session request to the message service application server according to the message triggering principle.

S2706: The message service information receiver home network judging module 520 in the message service application server judges that the home network of the message service information receiver is a traditional circuit switched network according to the message service information receiver identifier. The message service information transfer method judging module 532 judges that the message service information is carried via a session request. Optionally, the sequence of the two judgments may be inversed. The message service application server determines that the in-session message service information function control module 552 is in the in-session message service information function control unit according to local data configuration. The message service application server sends the session request to the in-session message service information function control unit.

S2708: The in-session message service information function control module 552 in the in-session message service information function control unit sends an ADD message to the in-session message service information function module 554. The message carries the in-session message service information transport address and/or the transport protocol, and/or the format type of the message service information, and/or the number of bytes of the message service information, of the message service information sender, for example:

```
MEGACO/3 [123.123.123.4]:55555
Transaction = 50003 {
  Context = $ {
    Add = A5555,
    Add = $ {Media {
      Stream = 1 {
          LocalControl {
          Mode = SendRecv,
          },
        Local {
v=0
s=−
c=IN IP4 $
t=0 0
m=message $ TCP/MSRP *
a=accept-types: image/jpeg
a=max-size:65536
}
          Remote {
v=0
o=− 2987933615 2987933615 IN IP4 123.123.123.1
s=−
c=IN IP4 123.123.123.1
t=0 0
m=message 3402 TCP/MSRP*
a=accept-types: image/jpeg
a=path:msrp://[ 123.123.123.1]:3402/s111271;tcp
a=max-size:131072
          }
        }
      }
Events = 0003 {cf}
Events = 0004 {ad}
    }
  }
}
```

S2710: The in-session message service information function unit sends a response of success to the in-session message service information function control unit. The response message carries the in-session message service information transport address and/or transport protocol, and/or the format type of the message service information, and/or the number of bytes of the message service information, of the in-session message service information function unit, for example:

```
MEGACO/3 [125.125.125.111]:55555
Reply = 50003 {
  Context = 5000 {
  Add = A5555,
    Add = A5556{
      Media {
        Stream = 1 {
          Local {
v=0
o=− 2987933615 2987933617 IN IP4 123.123.123.111
s=−
c=IN IP4 125.125.125.111
t=0 0
m=message 3402 TCP/MSRP *
a=accept-types: image/jpeg
a=path:msrp://[ 125.125.125.111]:3402/s234167;tcp
a=max-size:65536
}
        }
      }
    }
  }
}
```

S2712-S2716: The response is forwarded to the message service information sender.

S2718: Similar to S1710 in embodiment 201.

S2720: The in-session message service information function unit sends a notification to the in-session message service information function control unit, notifying the in-session message service information function control unit that the in-session message service information transport channel is set up successfully. The message carries an event named “Connection Finished” defined in the extended H.248 short message data package.

S2722: The in-session message service information function control unit sends a response to the in-session message service information function unit. S2720 to S2722 are optional steps.

S2724-S2726: Similar to S1712-S1714 in embodiment 201.

S2728: The in-session message service information function unit sends a notification to the in-session message service information function control unit, notifying the in-session message service information function control unit that in-session message service information has arrived. The message carries an event named “Short Message Arrived” defined in the extended H.248 short message data package.

S2730: The in-session message service information function control unit sends a response message to the in-session message service information function unit.

S2732: The in-session message service information function control module 552 in the in-session message service information function control unit sends an ADD message to the in-session message service information function module 554, requesting the in-session message service information function module 554 to deliver the message service information to the home multimedia message service network of the message service information receiver. The message carries the home multimedia message service network address information of the message information receiver defined in the extended H.248 short message data package, or carries Session Description Protocol (SDP) information.

S2734: The in-session message service information function unit sends a response message to the in-session message service information function control unit.

S2736: Similar to S1716 in embodiment 201.

The procedures in the in-session message service information function control module 552, the in-session message service information function module 554, and the in-session message service information transmitting interface module in this embodiment and the procedures in other modules in other embodiments can be combined to deduce the handling procedures and methods in combined situations, without further examples herein.

### Embodiment 205

FIG. 19 shows a message flow according to embodiment 205 of the invention.

The message service information receiver home network judging module 520 is placed in the message service application server; the message service information transfer method judging module 532 is placed in the message service application server; the in-session message service information function control module 552 is placed in another network entity, such as an in-session message service information function control unit; and the in-session message service information function module 554 and the in-session message service information transmitting interface module are in another network entity, such as an in-session message service information function unit.

The message flow of the embodiment is as follows:

S1902: Similar to S1802 in embodiment 202.

S1904: The CSCF transfers the session request to the message service application server according to the message triggering principle.

S1906: The message service information receiver home network judging module 520 in the message service application server judges that the home network of the message service information receiver is a traditional circuit switched network according to the message service information receiver identifier. The message service information transfer method judging module 532 judges that the message service information is carried via a session request. The message service application server determines that the in-session message service information function control module 552 is in another network entity according to local data configuration. The message service application server sends the session request to the in-session message service information function control module 552.

S1908: The in-session message service information function control module 552 selects an in-session message service information function module 554 and sends the message service information to the in-session message service information function module 554.

S1910: The in-session message service information function module 554 sends a response of success to the in-session message service information function control module 552.

S1912-S1916: The response is forwarded to the message service information transmitting module 510.

S1918-S1920: Similar to S1810-S1816 in embodiment 202.

The procedures in the in-session message service information function control module 552, the in-session message service information function module 554, and the in-session message service information transmitting interface module in this embodiment and the procedures in other modules in other embodiments can be combined to deduce the handling procedures and methods in combined situations, without further examples herein.

### Embodiment 206

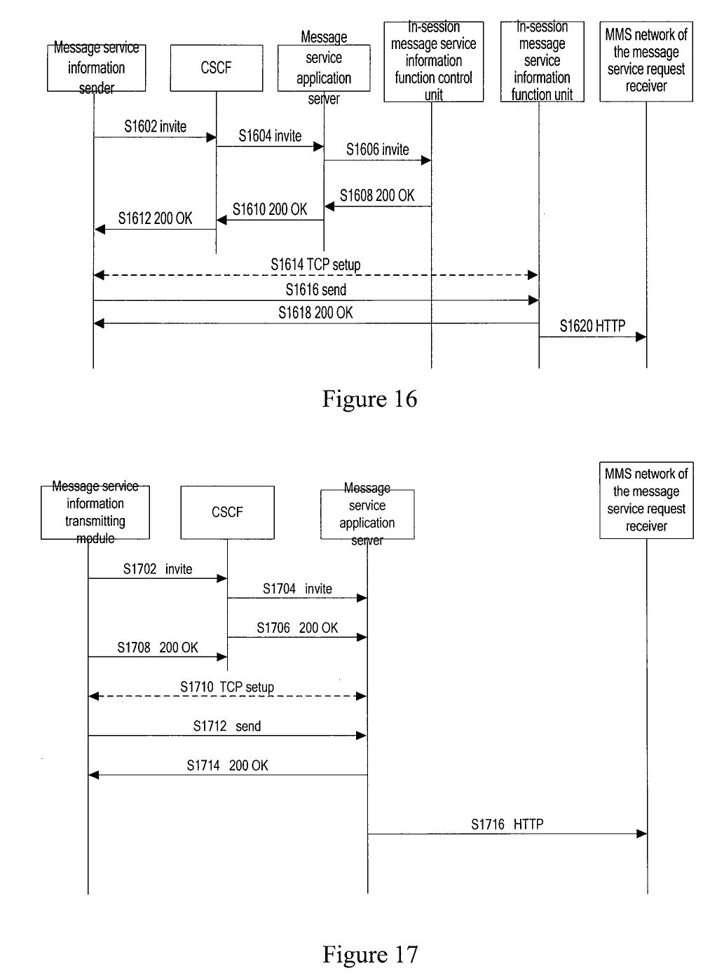

FIG. 16 shows a message flow according to embodiment 206 of the invention.

The message service information receiver home network judging module 520 is placed in the message service application server; the message service information transfer method judging module 532 is placed in the message service application server; the in-session message service information function control module 552 is placed in another network entity, such as an in-session message service information function control unit; and the in-session message service information function module 554 and the in-session message service information transmitting interface module are in another network entity, such as an in-session message service information function unit.

The in-session message service information function control module 552 and the in-session message service information function module 554 do not exchange messages. The in-session message service information function control unit sends a response to the message service information request to the message service information sender in step S1608. The response message carries information of the in-session message service information function unit about the setup of a message service information session. The information is pre-agreed between the in-session message service information function control module 552 and the in-session message service information function module 554.

The procedures in the in-session message service information function control module 552, the in-session message service information function module 554, and the in-session message service information transmitting interface module in this embodiment and the procedures in other modules in other embodiments can be combined to deduce the handling procedures and methods in combined situations, without further examples herein.

### Embodiment 207

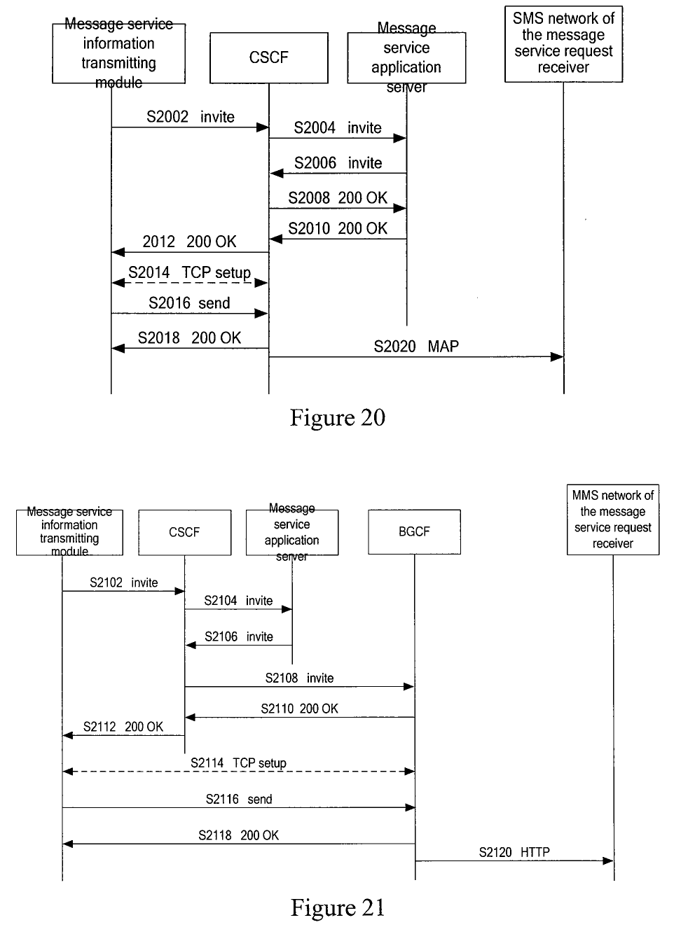

FIG. 20 shows a message flow according to embodiment 207 of the invention.

The message service information receiver home network judging module 520 is placed in the message service application server entity; the message service information transfer method judging module 532 is placed in the message service application server entity; the in-session message service information function control module 552 is placed in the CSCF entity; the in-session message service information function module 554 is placed in the CSCF entity; and the in-session message service information transmitting interface module is placed in the CSCF entity.

The message flow of the embodiment is as follows:

S2002: Similar to S1802 in embodiment 202.

S2004: The CSCF transfers the session request to the message service application server according to the message triggering principle.

S2006: The message service information receiver home network judging module 520 in the message service application server judges that the home network of the message service information receiver is a traditional circuit switched network according to the message service information receiver identifier. The message service information transfer method judging module 532 judges that the message service information is carried via a session request. Optionally, the sequence of the two judgments may be inversed. The message service application server determines that the in-session message service information function control module 552 is in the CSCF according to local data configuration. The message service application server sends the session request to the CSCF.

S2008: The in-session message service information function control module 552 in the CSCF assigns an in-session message service information function module 554 and returns a response of successful session setup to set up a session between the in-session message service information function module 554 and the message service information transmitting module 510. The response message carries message service response information.

S2010-S2012: The message service application server forwards the response message to the CSCF; the CSCF forwards the response to the message service information transmitting module 510.

S2014-S2020: Similar to S1814-S1820 in embodiment 202.

Based on this embodiment, the procedures when the modules are distributed as follows can be deduced:

The message service information receiver home network judging module 520 and the message service information transfer method judging module 532, the message service information content media format judging module 552, the in-session message service information function module 554, and the in-session message service information function control module 556 may be placed in network entities as follows according to the order of the message flow: the network entity in the first location is the message service application server and the network entity in the second location is the CSCF.

2) The distribution rule is as follows:

When the message service information receiver home network judging module 520 is in the message service application server entity and the in-session message service information transmitting module is in the CSCF entity, the message service information transfer method judging module 532, the in-session message service information function control module 552, and the in-session message service information function module 554 may be in any of the network entities described in 1) and the network entity of the message service information transfer method judging module 532 is in a position ahead of or in a same position as the network entity of the in-session message service information function module 554; and

When the message service information receiver home network judging module 520 is in the CSCF entity and the in-session message service transmitting module is in the CSCF entity, and the message service information transfer method judging module 532 is in the message service application server entity, the in-session message service information function control module 552 and the in-session message service information function module 554 may be in the CSCF entity or any network entity behind the CSCF entity described in 1) and the network entity of the in-session message service information function control module 552 is in a position ahead of or in a same position as the network entity of the in-session message service information function module 554.

### Embodiment 208

FIG. 21 shows a message flow according to embodiment 208 of the invention.

The message service information receiver home network judging module 520 is placed in the message service application server entity; the message service information transfer method judging module 532 is placed in the message service application server entity; the in-session message service information function control module 552 is placed in the BGCF entity; the in-session message service information function module 554 is placed in the BGCF entity; and the in-session message service information transmitting interface module is placed in the BGCF entity.

The message flow of the embodiment is as follows:

S2102: Similar to S1702 in embodiment 201.

S2104: Similar to S2004 in embodiment 208.

S2106: The message service information receiver home network judging module 520 in the message service application server judges that the home network of the message service information receiver is a traditional circuit switched network according to the message service information receiver identifier. The message service information transfer method judging module 532 judges that the message service information is carried via a session request. Optionally, the sequence of the two judgments may be inversed. The message service application server determines that the in-session message service information function control module 552 is in the BGCF according to local data configuration. The message service application server sends the session request to the BGCF.

S2108: The CSCF sends the message service information to the BGCF.

S2110: The in-session message service information function control module 552 in the BGCF assigns an in-session message service information function module 554 and returns a response of successful session setup to set up a session between the in-session message service information function module 554 and the message service information transmitting module 510. The response message carries message service response information.

S2112: The response is forwarded to the message service information transmitting module 510.

S2114-S2120: Similar to S1710-S1716 in embodiment 201.

Based on this embodiment, the procedures when the modules are distributed as follows can be deduced:

1) The message service information receiver home network judging module 520 and the message service information transfer method judging module 532, the message service information content media format judging module 552, the in-session message service information function module 554, and the in-session message service information function control module 556 may be placed in network entities as follows according to the order of the message flow: the network entity in the first position is the message service application server, the network entity in the second position is the CSCF, and the network entity in the third position is the BGCF.

2) The distribution rule is as follows:

When the message service information receiver home network judging module 520 is in the message service application server entity and the in-session message service information transmitting module is in the BGCF entity, the message service information transfer method judging module 532, the in-session message service information function control module 552, and the in-session message service information function module 554 may be in any of the network entities described in 1) and the network entity of the message service information transfer method judging module 532 is in a position ahead of or in a same position as the network entity of the in-session message service information function module 554, and the in-session message service information function control module 552 is in a position ahead of or in a same position as the network entity of the in-session message service information function module 554; and

When the message service information receiver home network judging module 520 is in the CSCF entity and the in-session message service transmitting module is in the MGCF entity, and the message service information transfer method judging module 532 is in the message service application server entity, the in-session message service information function control module 552 and the in-session message service information function module 554 may be in the CSCF entity or any network entity behind the CSCF entity described in 1) and the network entity of the in-session message service information function control module 552 is in a position ahead of or in a same position as the network entity of the in-session message service information function module 554.

### Embodiment 209

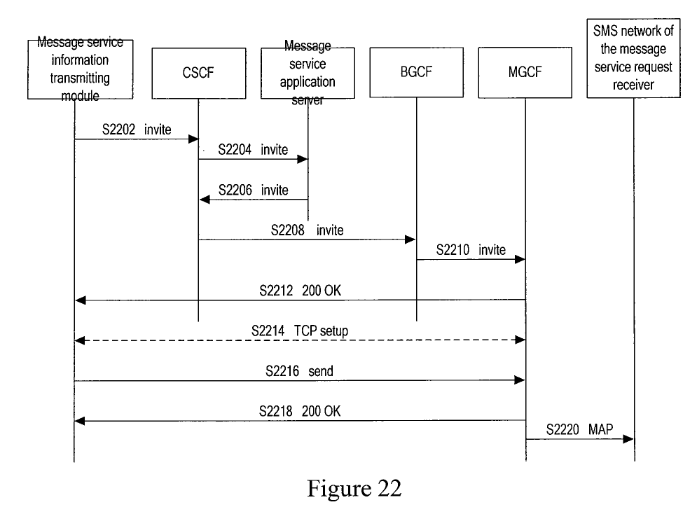

FIG. 22 shows a message flow according to embodiment 209 of the invention.

The message service information receiver home network judging module 520 is placed in the message service application server entity; the message service information transfer method judging module 532 is placed in the message service application server entity; the in-session message service information function control module 552 is placed in the MGCF entity; the in-session message service information function module 554 is placed in the MGCF entity; and the in-session message service information transmitting interface module is placed in the MGCF entity.

The message flow of the embodiment is as follows:

S2202: Similar to S1802 in embodiment 202.

S2204: Similar to S2004 in embodiment 207.

S2206: The message service application server determines that the home network of the message service information receiver is a traditional circuit switched network. The message service information transfer method judging module 532 judges that the message service information is carried via a session request. Or optionally, the sequence of the two judgments may be inversed. The message service application server determines that the in-session message service information function control module 552 is in the MGCF according to local data configuration and sends the message service information to the MGCF.

S2208-S2210: The CSCF sends the message service information to the MGCF.

S2212: The in-session message service information function control module 552 in the MGCF assigns an in-session message service information function module 554 and returns a response of successful session setup to set up a session between the in-session message service information function module 554 and the message service information transmitting module 510. The response message carries message service response information.

S2214-S2220: Similar to S1814-S1820 in embodiment 202.

Based on this embodiment, the procedures in the following scenarios can be deduced:

Based on this embodiment, the procedures when the modules are distributed as follows can be deduced:

The message service information receiver home network judging module 520 and the message service information transfer method judging module 532, the in-session message service information function control module 552, the in-session message service information function module 554, and the in-session message service information transmitting interface module may be placed in network entities as follows according to the order of the message flow: the network entity in the first position is the message service application server, the network entity in the second position is the CSCF, and the third position is the BGCF, and the network entity in the fourth position is the MGCF; or the network entity in the first position is the message service application server, the network entity in the second position is the CSCF, and the network entity in the third position is the MGCF.

2) The distribution rule is as follows:

When the message service information receiver home network judging module 520 is in the message service application server entity and the in-session message service information transmitting module is in the MGCF entity, the message service information transfer method judging module 532, the in-session message service information function control module 552, and the in-session message service information function module 554 may be in any of the network entities described in 1) and the network entity of the message service information transfer method judging module 532 is in a position ahead of or in a same position as the network entity of the in-session message service information function module 554; and

When the message service information receiver home network judging module 520 is in the CSCF entity and the in-session message service transmitting module is in the MGCF entity, and the message service information transfer method judging module 532 is in the message service application server entity, the in-session message service information function control module 552 and the in-session message service information function module 554 may be in the CSCF entity or any network entity behind the CSCF entity described in 1) and the network entity of the in-session message service information function control module 552 is in a position ahead of and in a same position as the network entity of the in-session message service information function module 554.

### Embodiment 211

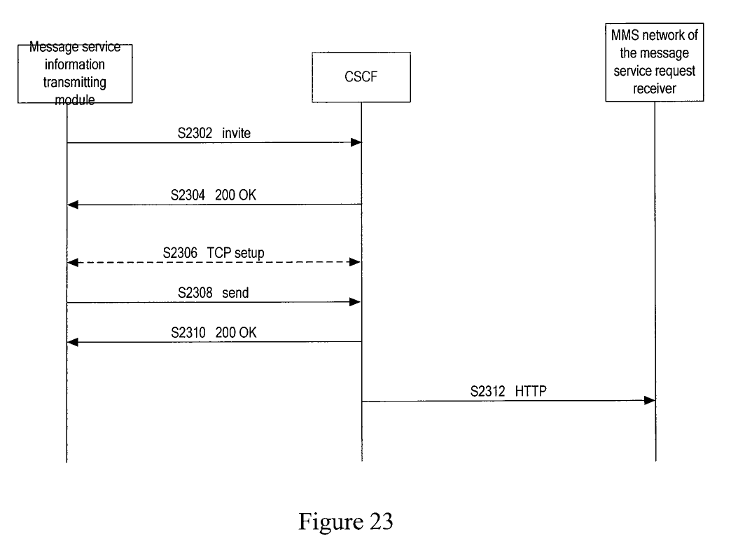

FIG. 23 shows a message flow according to embodiment 211 of the invention.

The message service information receiver home network judging module 520 is placed in the CSCF entity; the message service information transfer method judging module 532 is placed in the CSCF entity; the in-session message service information function control module 552 is placed in the CSCF entity; and the in-session message service information function module 554 is place in the CSCF entity.

The message flow of the embodiment is as follows:

S2302: Similar to S1702 in embodiment 201.

S2304: The message service information receiver home network judging module 520 in the CSCF judges that the home network of the message service information receiver is a traditional circuit switched network according to the message service information receiver identifier. The message service information transfer method judging module 532 judges that the message service information is carried via a session request message. Or, optionally, the sequence of the two judgments may be inversed. The in-session message service information function control module 552 assigns an in-session message service information function module 554. The in-session message service information function control module 552 in the CSCF returns a response of successful session setup to set up a session between the in-session message service information function module 554 and the message service information transmitting module 510. The response message carries message service response information.

S2306-S2312: Similar to S1710-S1716 in embodiment 201.

### Embodiment 212

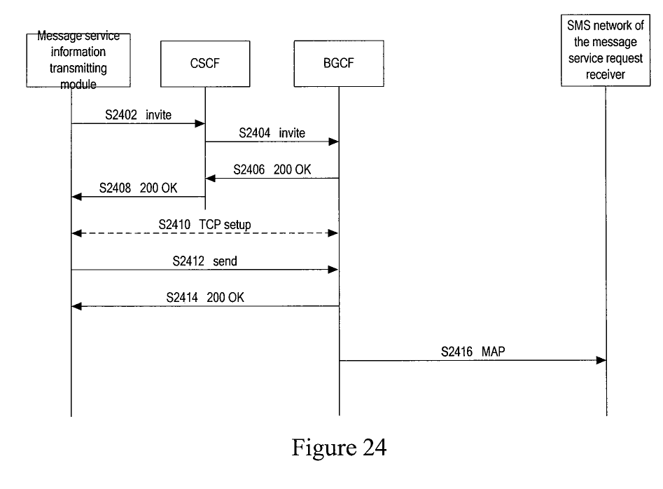

FIG. 24 shows a message flow according to embodiment 212 of the invention.

The message service information receiver home network judging module 520 is placed in the CSCF entity; the message service information transfer method judging module 532 is placed in the CSCF entity; the in-session message service information function control module 552 is placed in the BGCF entity; and the in-session message service information function module 554 is place in the BGCF entity.

The message flow of the embodiment is as follows:

S2402: Similar to S1802 in embodiment 202.

S2404: The message service information receiver home network judging module 520 in the CSCF judges that the home network of the message service information receiver is a traditional circuit switched network according to the message service information receiver identifier. The message service information transfer method judging module 532 judges that the message service information is carried via a session request. Optionally, the sequence of the two judgments may be inversed. The message service application server determines that the in-session message service information function control module 552 is in the BGCF according to local data configuration. The CSCF sends the session request to the BGCF.

S2406: The in-session message service information function control module 552 in the BGCF assigns an in-session message service information function module 554 and returns a response of successful session setup to set up a session between the in-session message service information function module 554 and the message service information transmitting module 510. The response message carries message service response information.

S2408: The CSCF forwards the response to the message service information transmitting module 510.

S2410-S2416: Similar to S1814 S1820 in embodiment 202.

Based on this embodiment, the procedures when the modules are distributed as follows can be deduced:

1) The message service information receiver home network judging module 520 and the message service information transfer method judging module 532, the message service information content media format judging module 552, the in-session message service information function module 554, and the in-session message service information function control module 556 may be placed in network entities as follows according to the order of the message flow: the network entity in the first position is the CSCF and the network entity in the second position is the BGCF.

2) The distribution rule is as follows:

When the message service information receiver home network judging module 520 is in the CSCF entity and the message service information transfer method judging module 532 is in the CSCF entity, and the in-session message service information transmitting interface module is in the BGCF, the in-session message service information function control module 552 and the in-session message service information function module 554 may be in the CSCF entity or any network entity behind the CSCF entity described in 1) and the network entity of the in-session message service information function control module 552 is in a position ahead of and in a same position as the network entity of the in-session message service information function module 554.

### Embodiment 213

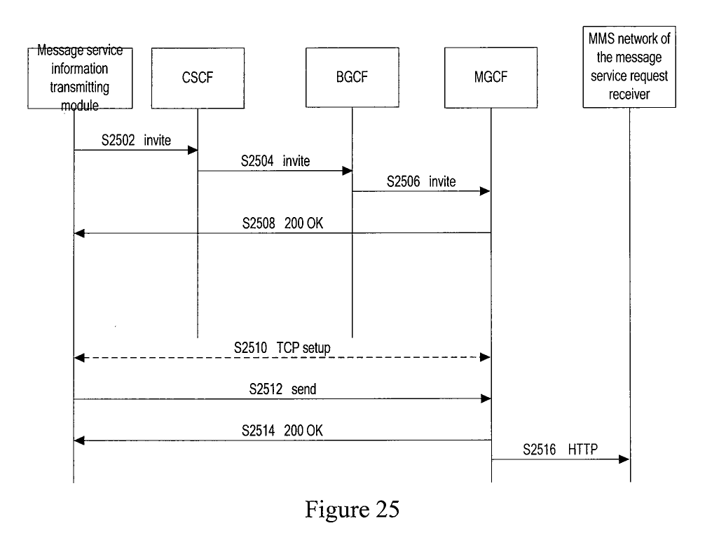

FIG. 25 shows a message flow according to embodiment 213 of the invention.

The message service information receiver home network judging module 520 is placed in the CSCF entity; the message service information transfer method judging module 532 is placed in the CSCF entity; the in-session message service information function control module 552 is placed in the MGCF entity; and the in-session message service information function module 554 is place in the MGCF entity.

The message flow of the embodiment is as follows:

S2502: Similar to S1702 in embodiment 201.

S2504: The message service information receiver home network judging module 520 in the CSCF judges that the home network of the message service information receiver is a traditional circuit switched network according to the message service information receiver identifier. The message service information transfer method judging module 532 judges that the message service information is carried via a session request. Optionally, the sequence of the two judgments may be inversed. The message service application server determines that the in-session message service information function control module 552 is in the MGCF according to local data configuration. The CSCF sends the session request to the MGCF.

S2506: The border session control function sends the message service information to the MGCF.

S2508: The in-session message service information function control module 552 in the MGCF assigns an in-session message service information function module 554 and returns a response of successful session setup to set up a session between the in-session message service information function module 554 and the message service information transmitting module 510. The response message carries message service response information.

S2510: The response is forwarded to the message service information transmitting module 510.

S2512-S2516: Similar to S1712-S1716 in embodiment 201.

Based on this embodiment, the procedures when the modules are distributed as follows can be deduced:

1) The message service information receiver home network judging module 520 and the message service information transfer method judging module 532, the in-session message service information function control module 552, the in-session message service information function module 554, and the in-session message service information transmitting interface module may be placed in network entities as follows according to the order of the message flow: the network entity in the first position is the CSCF, the network entity in the second position is the BGCF, and the third position is the MGCF; or network entity in the first position is the CSCF, and the network entity in the second position is the MGCF.

2) The distribution rule is as follows:

When the message service information receiver home network judging module 520 is in the CSCF entity and the message service information transfer method judging module 532 is in the CSCF entity, and the in-session message service information transmitting interface module is in the MGCF, the in-session message service information function control module 552 and the in-session message service information function module 554 may be in the CSCF entity or any network entity behind the CSCF entity described in 1) and the network entity of the in-session message service information function control module 552 is in a position ahead of or in a same position as the network entity of the in-session message service information function module 554.

With reference to embodiment 102, the procedure in another entity accessed by the out-session multimedia message service information interworking interface module 564 or the out-session text message service information interworking interface module 566 via the network entity in the last position can be deduced for embodiments 103-113.

With reference to embodiments 202-206, the procedures in other same or different entities respectively accessed by the in-session message service information function control module 552, the in-session message service information function module 554, and the in-session message service information transmitting interface module via the network entity in the last position can be deduced for embodiments 207-213.

Based on all the embodiments, the processing methods in the following scenarios can be deduced:

1) Multimedia message service information is sent to the home multimedia message service network of the message service information receiver;

2) Multimedia message service information is sent to the home text message service network of the message service information receiver;

3) Text message service information is sent to the home text message service network of the message service information receiver; and

4) Text message service information is sent to the home multimedia message service network of the message service information receiver.

When there is only in-session or out-session message service information in the entire network, the operations in the message service information transfer method judging module may be omitted. The message service information receiver home network judging module 520 directly delivers the message service information to the in-session message service information interworking interface module 550 or the out-session message service information interworking interface module 560.

The technical solution provided by embodiments of the invention judges that the home network of the message service information receiver is a traditional circuit switched network according to the message service information receiver identifier, judges that the message service information is carried via a session request message, and then transfers the message service information to the home short message network of the message service information receiver. With the technical solution, the network is able to route a message to the IP-Messaging-GW when a UE accesses. The technical solution also solves the interworking between non-session based message service and the multimedia message service as well as the interworking between session-based message service and the message service in a heterogeneous network such as the traditional circuited switched domain.

It should be understood that the above message service routing method is applicable to the message service interworking between the home network of the message service information transmitting module and a heterogeneous network. The heterogeneous network is a network that has an architecture different from that of the home network of the message service information transmitting module. For example, when the home network of the message service information transmitting module is an IMS network or another SIP network, a traditional circuit-switched network or a packet switched network is a heterogeneous network of the home network of the message service information transmitting module.

From the above description, it can be seen that the embodiments of the invention achieve the following technical benefits:

The technical solution provided by embodiments of the invention judges that the home network of the message service information receiver is a traditional circuit switched network according to the message service information receiver identifier, judges that the message service information is carried via a session request message, and then transfers the message service information to the home short message network of the message service information receiver. With the technical solution, the network is able to route a message to the IP-Messaging-GW when a UE accesses. The technical solution also solves the interworking between non-session based message service and the multimedia message service as well as the interworking between session-based message service and the message service in a heterogeneous network such as the traditional circuited switched domain.

Although the technical scheme of the present invention has been described through exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the claims or their equivalents.

What is claimed is:

1. A message service routing apparatus, comprising:
a message service information transmitting module, configured to send a request, wherein the request carries a message service information associating a message service information receiver;
a message service information route selecting module, configured to receive the request and send the message service information carried in the request; and
a message service information interworking interface module, configured to receive the message service information and send the message service information to a home network of the message service information receiver.

2. The message service routing apparatus of claim 1, wherein the message service information route selecting module comprises a message service information receiver home network judging module, and wherein the message service information receiver home network judging module is configured to determine a type of home network of the message service information receiver based on a message service information receiver identifier carried in the message service information.

3. The message service routing apparatus of claim 2, wherein when the message service information receiver home network judging module determines that the home network of the message service information receiver is a heterogeneous network, the message service information route selecting module transmits the message service information to the message service information interworking interface module.

4. The message service routing apparatus of claim 1, wherein the message service information route selecting module comprises a message service information transfer method judging module, and wherein the message service information transfer method judging module is configured to judge whether the message service information is transferred in session or outside session.

5. The message service routing apparatus of claim 2, wherein the message service information interworking interface module comprises an out-session message service information interworking interface module configured to transmit an out-session message service information to the home network the message service information receiver.

6. The message service routing apparatus of claims 5, wherein the message service information interworking interface module further comprises at least one of the following modules:
an out-session multimedia message service information interworking interface module, configured to send an out-session message service information to the home network of the message service information receiver; and
an out-session text message service information interworking interface module, configured to send an out-session message service information to the home network of the message service information receiver.

7. The message service routing apparatus of claim 6, wherein the message service information interworking interface module further comprises a message service information receiver home content media format judging module, and wherein the message service information receiver home content media format judging module is configured to check the content format of the out-session message service information, and wherein the context format comprises a multimedia format and a text format.

8. The message service routing apparatus of claim 6, wherein the message service information route selecting module comprises at least one of the following modules:
a first message service information transmitting module, configured to send the out-session message service information to the out-session multimedia message service information interworking interface module, wherein the out-session multimedia message service information interworking interface module sends the out-session message service information to the home network of the message service information receiver, and wherein
a second message service information transmitting module, configured to send the out-session message service information to the out-session text message service information interworking interface module, wherein the out-session text message service information interworking interface module sends the out-session message service information to the home network of the message service receiver.

9. The message service routing apparatus of claim 7, wherein the message service information route selecting module comprises at least one of the following modules:
a third message service information transmitting module, configured to send an out-session message service information to the message service information receiver home content media format judging module to judge, when the format of the out-session message service information is media format, the message service information receiver home content media format judging module sends the out-session message service information to the out-session media message service information interworking interface module, and the out-session media message service information interworking interface module sends the out-session message service information to the home network of the message service information receiver;
a fourth message service information transmitting module, configured to send an out-session message service information to the message service information receiver home content media format judging module to judge, when the format of the out-session message service information is media format, the message service information receiver home content media format judging module sends the out-session message service information to the out-session text message service information interworking interface module, and the out-session text message service information interworking interface module sends the out-session message service information to the home network of the message service information receiver;
a fifth message service information transmitting module, configured to send an out-session message service information to the message service information receiver home content media format judging module to judge, when the format of the out-session message service information is text format, the message service information receiver home content media format judging module sends the out-session message service information to the out-session text message service information interworking interface module, and the out-session text message service information interworking interface module sends the out-session message service information to the home network of the message service information receiver; and
a sixth message service information transmitting module, configured to send an out-session message service information to the message service information receiver home content media format judging module to judge, when the format of the out-session message service information is text format, the message service information receiver home content media format judging module sends the out-session message service information to the out-session media message service information interworking interface module, and the out-session media message service information interworking interface module sends the out-session message service information to the home network of the message service information receiver.

10. The message service routing apparatus of claim 2, wherein the message service information interworking interface module comprises an in-session message service information interworking interface module configured to transmit the in-session message service information to the home network of the message service information receiver.

11. The message service routing apparatus of claim 10, wherein the in-session message service information interworking interface module comprises:
an in-session message service information control module, configured to control setting up and tearing down a session stream between the message service information transmitting module and the in-session message service information interworking interface module;
an in-session message service information functional module, configured to set up and tear down a session stream between the message service information transmitting module and the in-session message service information interworking interface module and extract message service information of the session stream, wherein the in-session control module sends the message service information to an in-session transmitting interface module, and wherein the in-session transmitting interface module sends the message service information to the home network of the message service information receiver.

12. The message service routing apparatus of claim 11, wherein the in-session message service information receiver home control module controls the in-session message service information module to extract the message service information from the session media stream.

13. The message service routing apparatus of claim 12, wherein the in-session message service information interworking interface module comprises:
a session set-up module, configured to set up a session between the in-session message service information module and the message service information message service information transmitting module when the in-session message service information interworking interface module sends a response of the message service information session request to the message service information message service information transmitting module; and
a sending module, configured to enable the in-session message service information message service information transmitting module to send the in-session message service information to the in-session message service information interworking interface module, wherein the in-session message service information interworking interface module sends the in-session message service information to the in-session message service information transmitting interface module.

14. The message service routing apparatus of claim 13, wherein the session set-up module comprises at least one of the following modules:
a first session set-up module, configured to enable the in-session message service information control module to send the response to the message service information session request to the message service information message service information transmitting module, and set up the session between the in-session message service information control module and the message service information message service information transmitting module; and
a second session set-up module, configured to enable the in-session message service information control module to send a control message to the in-session message service information module, wherein the control message carries a message service information request, the in-session message service information module assigns the message service information resource, and feeds back the response message to the in-session message service information control module, and the response message carries the response message; and wherein the in-session message service information control module sends a session request message to the in-session message service information message service information transmitting module, and sets up the session between the in-session message service information module and the in-session message service information message service information transmitting module.

15. The message service routing apparatus of claim 13, wherein the session set-up module comprises at least one of the following modules:
a third session set-up module, configured to send a call information to a call request receiver, wherein the in-session control module sends the response information to the message service information session request to the message service information transmitting module to set up the session between the in-session functional module and the message service information transmitting module, and wherein the response to the message service information session request is carried in the call session setup success response message; and
a fourth session set-up module, configured to send a call information to a call request receiver, wherein the in-session control module sends a control message carrying a message service information request to the in-session functional module and enable the in-session functional module to provide session resource, and wherein the in-session functional module assigns the session resource, sends a call session setup success response message to the in-session control module, and sets up the session between the in-session functional module and the message service information transmitting module.

16. The message service routing apparatus of claim 13, wherein the message service information transmitting module comprises at least one of the following modules:
a seventh message service information transmitting module, configured to send a notify message to the in-session message service information control module when the in-session message service information module receives the message service information, and wherein the in-session message service information control module sends a indication message to the in-session message service information module and indicates the in-session message service information module to send the in-session message service information to the in-session message service information transmitting interface module; and
an eighth message service information transmitting module, configured to extract the message service information when the in-session message service information module receives the message service information, and sends the message service information to the in-session message service information transmitting interface module.

17. A message service routing method, comprising:
sending a request, carrying a message service information and an identification of a message service information receiver corresponding to the message service information receiver;
determining whether the message service information receiver is a traditional electrical domain user based on the identification of the message service information receiver; and
transmitting the message service information to a home network of the message service information receiver when the message service information receiver is a traditional electrical domain user.

18. The message service routing method of claim 17, wherein the step of determining whether the message service information receiver is a traditional electrical domain user further comprises: analyzing the identification of the message service information receiver by querying Domain Name Server or Telephone Number Mapping or checking the local configuration of the message service application server.

19. The message service routing method of claim 17, further comprising determining the message service information is in-session message service information or outside-session message service information according to a style of the session information.

20. The message service routing method of claim 17, wherein the step of sending the message service information to the home network of the message service information receiver comprising at least one of the following:
transmitting the message service information to the multimedia message service network of the message service information receiver;
transmitting the message service information to the text message service network of the message service information receiver;
checking the content format of the message service information, and when the format of the message service information is multimedia, transmitting the message service information to the multimedia message service network of the message service information receiver;
checking the content format of the message service information, and when the format of the message service information is multimedia, transmitting the message service information to the text message service network of the message service information receiver;
checking the content format of the message service information, and when the format of the message service information is text, transmitting the message service information to the text message service network of the message service information receiver; and
checking the content format of the message service information, and when the format of the message service information is text, transmitting the message service information to the multimedia message service network of the message service information receiver.
